(19) United States
(12) Patent Application Publication
(10) Pub. No.: US 2023/0088453 A1
(43) Pub. Date: Mar. 23, 2023

(54) CRAWLER TRAVELING BODY AND TRAVELING DEVICE

(71) Applicants: Hiroshi SHIMURA, Kanagawa (JP); Taku KITAHARA, Tokyo (JP); Hiroshi OKAMOTO, Kanagawa (JP); Eichi KOIZUMI, Kanagawa (JP)

(72) Inventors: Hiroshi SHIMURA, Kanagawa (JP); Taku KITAHARA, Tokyo (JP); Hiroshi OKAMOTO, Kanagawa (JP); Eichi KOIZUMI, Kanagawa (JP)

(21) Appl. No.: 17/947,184

(22) Filed: Sep. 19, 2022

(30) Foreign Application Priority Data
Sep. 21, 2021 (JP) 2021-153407
Aug. 8, 2022 (JP) 2022-126316

(51) Int. Cl. B60T 1/06; B62D 55/14; B62D 55/125; B60T 13/74; F16D 55/225

(52) U.S. Cl. CPC B60T 1/065; B62D 55/14; B62D 55/125; B60T 13/746; F16D 55/225; F16D 2121/24

(57) ABSTRACT

A crawler traveling body includes: a wheel around which a crawler belt is wound; a disc; a disc connector configured to connect the wheel and the disc, and rotate the wheel and the disc together; a brake caliper configured to sandwich the disc with a brake pad; and a motor configured to open or close the brake pad according to a control signal for controlling a degree of opening or closing of the brake pad.

### CROSS-REFERENCE TO RELATED APPLICATIONS

This patent application is based on and claims priority genuine to 35 U.S. C. § 119 (a) to Japanese Patent Application Nos. 2021-153407, filed on Sep. 21, 2021, and 2022-126316, filed on Aug. 8, 2022, in the Japan Patent Office, the entire disclosure of which is herein incorporated by reference herein.

### BACKGROUND

### Technical Field

The present invention relates to a crawler traveling body and a traveling device including the same.

### Related Art

The background crawler traveling device travels using a crawler belt wound around a wheel.

The background brake mechanism supplies a part of pressure oil, to be supplied to a hydraulic motor, to a cylinder chamber on the release side of a parking brake, releases the parking brake during traveling, and activating the parking brake to stop traveling. Such brake function, based on hydraulic control, is usually applied to a large-size crawler mobile body.

### SUMMARY

A crawler traveling body includes: a wheel around which a crawler belt is wound; a disc; a disc connector configured to connect the wheel and the disc, and rotate the wheel and the disc together; a brake caliper configured to sandwich the disc with a brake pad; and a motor configured to open or close the brake pad according to a control signal for controlling a degree of opening or closing of the brake pad.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings.

FIGS. 1A, 1B, and 1C (FIG. 1) are views illustrating an example configuration of a traveling device according to an embodiment.

FIG. 2 is a view illustrating an example traveling state of the traveling device according to the embodiment.

FIG. 3 is a view illustrating an example configuration of a crawler traveling body according to the embodiment.

FIG. 4 is another view illustrating an example configuration of the crawler traveling body according to the embodiment.

FIGS. 5A and 5B (FIG. 5) are views illustrating an example configuration of a tensioner of the crawler traveling body according to the embodiment.

FIG. 6 is a perspective view illustrating an example of a detailed configuration of the tensioner included in the crawler traveling body according to the embodiment.

FIG. 7 is a view illustrating a state of the tensioner included in the crawler traveling body according to the embodiment.

FIGS. 8A and 8B (FIG. 8) are views illustrating an example configuration of a side plate included in the crawler traveling body according to the embodiment.

FIG. 9 is a view illustrating an example configuration of the side plate included in the crawler traveling body according to the embodiment.

FIG. 10 is a view illustrating an example configuration of the side plate included in the crawler traveling body according to the embodiment.

FIGS. 11A, 11B, and 11C (FIG. 11) are views each illustrating an example configuration of the driving wheel included in the crawler traveling body according to the embodiment.

FIGS. 12A, 12B, and 12C (FIG. 12) are views each illustrating an example configuration of a rolling wheel included in the crawler traveling body according to the embodiment.

FIG. 13 is a view illustrating an example internal structure of an axle of a rolling wheel included in the crawler traveling body according to the embodiment.

FIG. 14 is a view illustrating an example configuration of an auxiliary mechanism included in the crawler traveling body according to the embodiment.

FIG. 15 is a diagram illustrating an example internal structure of a link included in the crawler traveling body according to the embodiment.

FIGS. 16A, 16B, and 16C (FIG. 16) are views each illustrating an example configuration of an idler included in the crawler traveling body according to the embodiment.

FIG. 17 is a view illustrating an example detailed configuration of the auxiliary mechanism included in the crawler traveling body according to the embodiment.

FIG. 18 is a view illustrating an example detailed configuration of the auxiliary mechanism included in the crawler traveling body according to the embodiment.

FIG. 19 is a graph illustrating an example relationship between a push-up amount and a push-down amount in the auxiliary mechanism provided in the crawler traveling body according to the embodiment.

FIG. 20 is a graph illustrating another example relationship between a push-up amount and a push-down amount in the auxiliary mechanism provided in the crawler traveling body according to the embodiment.

FIGS. 21A and 21B (FIG. 21) are graphs each illustrating another relationship between a push-up amount and a push-down amount in the auxiliary mechanism provided in the crawler traveling body according to the embodiment.

FIG. 22 is a graph illustrating another relationship between a push-up amount and a push-down amount in the auxiliary mechanism provided in the crawler traveling body according to the embodiment.

FIG. 23 is a side view illustrating the crawler traveling body according to the embodiment.

FIGS. 24A and 24B (FIG. 24) are each a diagram illustrating an example configuration of a disc brake included in the traveling device according to the embodiment.

FIG. 25 is a diagram illustrating an example of a basic structure of the gear box in the disc brake of the traveling device according to the embodiment.

FIG. 26 is a view illustrating another example method of mounting the disc brake of the traveling device according to the embodiment.

FIG. 27 is a block diagram illustrating an example hardware configuration of the traveling device according to the embodiment.

FIG. 28 is a flowchart illustrating an example processing of controlling autonomous traveling of the traveling device according to the embodiment.

FIG. 29 is a diagram illustrating an example hardware configuration of a brake controller included in the traveling device according to the embodiment.

FIG. 30 is a flowchart illustrating example processing executed by the brake controller included in the traveling device according to the embodiment.

FIG. 31 is a flowchart illustrating example processing of controlling a motor, performed by the brake controller of the traveling device, according to the embodiment.

FIG. 32 is a flowchart illustrating example processing of updating the position table by the traveling device according to the embodiment.

FIG. 33 is a diagram illustrating example processing of updating the position table by the traveling device according to the embodiment.

FIG. 34 is a diagram schematically illustrating a mechanism to release the brake pads in response to pressing of the brake release SW at the traveling device, according to the embodiment.

FIG. 35 is a flowchart illustrating example processing of releasing the brake pads in response to pressing of the brake release SW at the traveling device according to the embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. Referring now to the drawings, embodiments of the present disclosure are described below. As used herein, the singular forms “a,” “an,” and “the” are intended to include the plural forms as well, unless the context clearly indicates otherwise.

Embodiments of a crawler traveling device will be described in detail below with reference to the accompanying drawings.

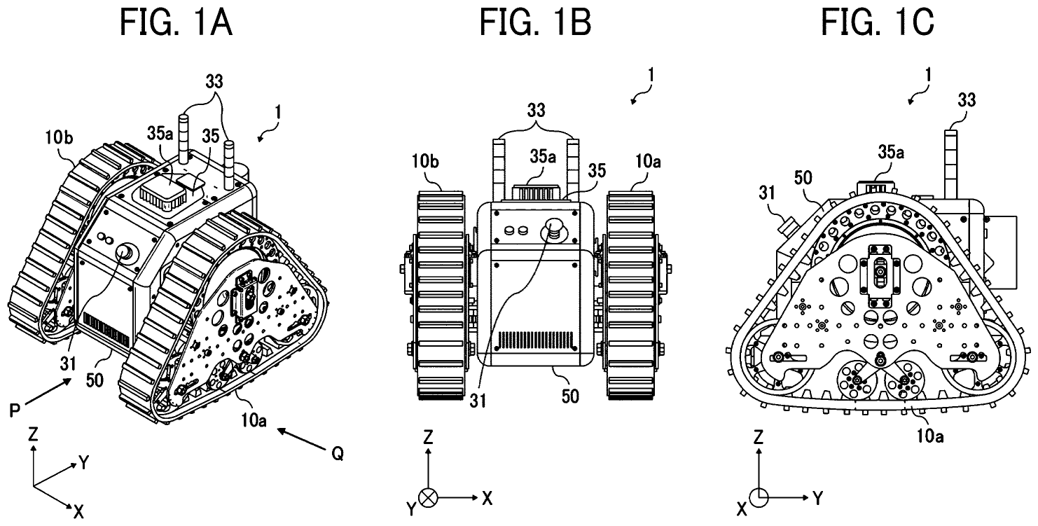

First, referring to FIGS. 1A to 1C, an example configuration of a traveling device 1 is described according to an embodiment. FIGS. 1A to 1C are each a diagram illustrating an example configuration of the traveling device 1 according to the embodiment.

FIG. 1A is a perspective view of an outer appearance of the traveling device 1 according to the embodiment. The traveling device 1 includes crawler traveling bodies 10a and 10b and a main body 50.

The crawler traveling bodies 10a and 10b are a unit serving as traveling means for the traveling device 1. The crawler traveling bodies 10a and 10b are each implemented by a crawler traveling body using a metallic or rubber belt. Compared with a traveling body that travels with tire, such as an automobile, the crawler traveling body has a wider contact area with the ground, so that the travel is more stable even in an environment with bad footing, for example. While the traveling body that travels with tire requires a space to make a turn, the traveling device with the crawler traveling body can perform a so-called super pivot turn, so that the traveling device can smoothly turn even in a limited space. Detailed configurations of the crawler traveling bodies 10a and 10b will be described below.

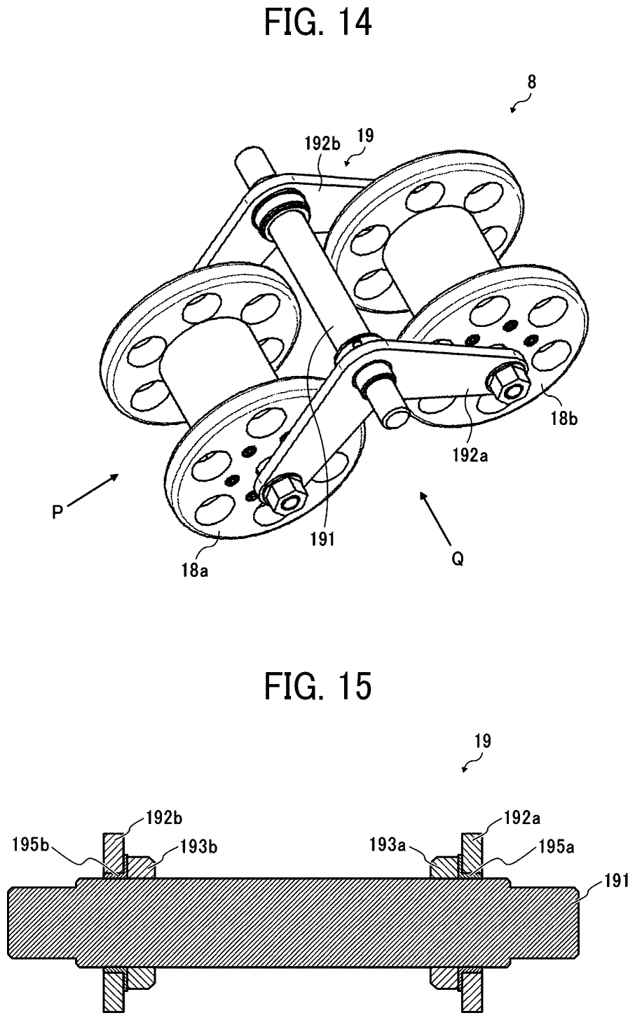

The main body 50 is a support body that supports the crawler traveling bodies 10a and 10b while allowing them to travel, which functions as a controller that controls driving of the traveling device 1. The main body 50 is equipped with a battery 1515 (see FIG. 15) to be described later, that supplies electric power for driving the crawler traveling bodies 10a and 10b.

FIG. 1B is a front view (a view seen from the arrow P in FIG. 1A) of the traveling device 1 according to the embodiment. The main body 50 of the traveling device 1 includes an emergency stop button 31, state display lamps (collectively, referred to as the state display lamp) 33, and a lid 35.

The emergency stop button 31 is an operation unit, which is pressed by a person around the traveling device 1 to stop the traveling device 1 during traveling.

The state display lamp 33 is a notification unit, which notifies the state of the traveling device 1. For example, when the state of the traveling device 1 changes due to a decrease in the remaining battery level, the state display lamp 33 lights up to inform a person nearby of the state change of the traveling device 1. In addition, the state display lamp 33 is turned on in a case where there is a possibility that an abnormality occurs, for example, in a case where the presence of an obstacle that obstructs the traveling of the traveling device 1 is detected. Although FIG. 1B illustrates an example in which two state display lamps 33 are provided in the traveling device 1, the number of the state display lamps 33 may be one or three or more. In alternative to the state display lamp 33, any other notification unit may be used to notify the state of the traveling device 1, for example, a speaker that outputs a warning sound.

The lid 35 is provided on the upper surface of the main body 50 and seals the inside of the main body 50. The lid 35 has a ventilation part (air vent) 35a with ventilation holes through which air flows from or to the inside of the main body 50.

The two crawler traveling bodies 10a and 10b are provided so as to interpose the main body 50 therebetween, such that crawler belts 11a and 11b, which will be described later, are substantially parallel to each other. This structure allows the traveling device 1 to be movable. The number of crawler traveling bodies is not limited to two, and may be three or more. For example, the traveling device 1 may be provided with three crawler traveling bodies that are aligned in three rows in parallel, allowing the traveling device 1 to be movable. In another example, the traveling device 1 may be provided with four crawler traveling bodies, which are arranged in the front-rear direction and the left-right direction like tires of an automobile.

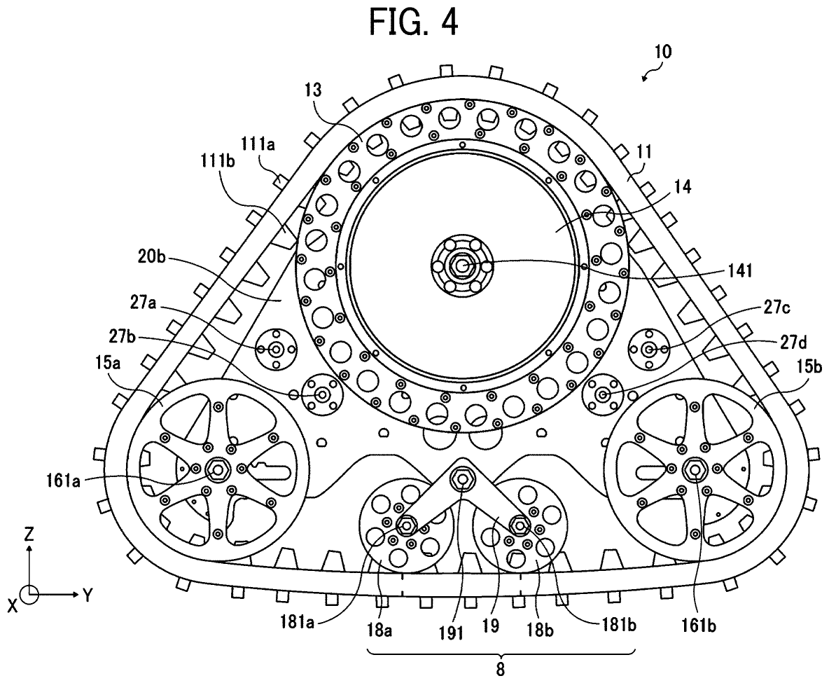

FIG. 1C is a side view (a view seen from the arrow Q in FIG. 1A) of the traveling device 1 according to the embodiment. The crawler traveling body 10a has a triangular shape formed by a driving wheel 13 (see FIG. 4) and two rolling wheels 15a and 15b (see FIG. 4), which will be described later. With this triangular shape, even when the length of the traveling body in the front-rear direction is to be fit into a predetermined length, the crawler traveling body 10a is able to increase its contact area contacting the ground, thus improving stability when traveling. In case of a so-called tank-type crawler having an upper side (driving wheel side) longer than a lower side (rolling wheel side), when there is a restriction on the front-rear direction length, a contact area contacting the ground is generally small, causing traveling to be unstable. As described above, the crawler traveling body 10a is effective in improving traveling performance, especially when applied to the traveling device 1 having relatively a small size.

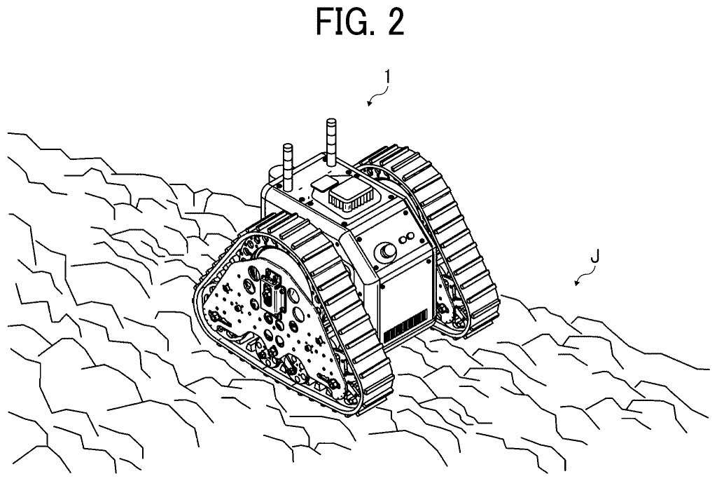

Next, referring to FIG. 2, operation of the traveling device 1 while traveling is described. FIG. 2 is a diagram illustrating an example of a traveling state of the traveling device 1 according to the embodiment. The traveling device 1 can stably travel even on an irregular ground J as illustrated in FIG. 2, with the crawler traveling bodies 10a and 10b as illustrated in FIG. 1.

Due to unevenness of a travelling surface of the irregular ground J, the crawler traveling body may not be able to have a contact with the ground or may float from the ground, at least partly. In view of this, there is a traveling body equipped with an independent suspension, such that each wheel independently moves along a traveling surface. However, such traveling body tends to have a relatively large size. It has been difficult to adopt such mechanism to a small-sized traveling body in terms of installation size and component cost.

The traveling device 1 according to this embodiment uses the crawler traveling bodies 10a and 10b provided with an auxiliary mechanism 8 (see FIG. 4) described later, such that each wheel is able to move independently from each other along the traveling surface. This can increase a contact area with the ground, thus improving stability when traveling.

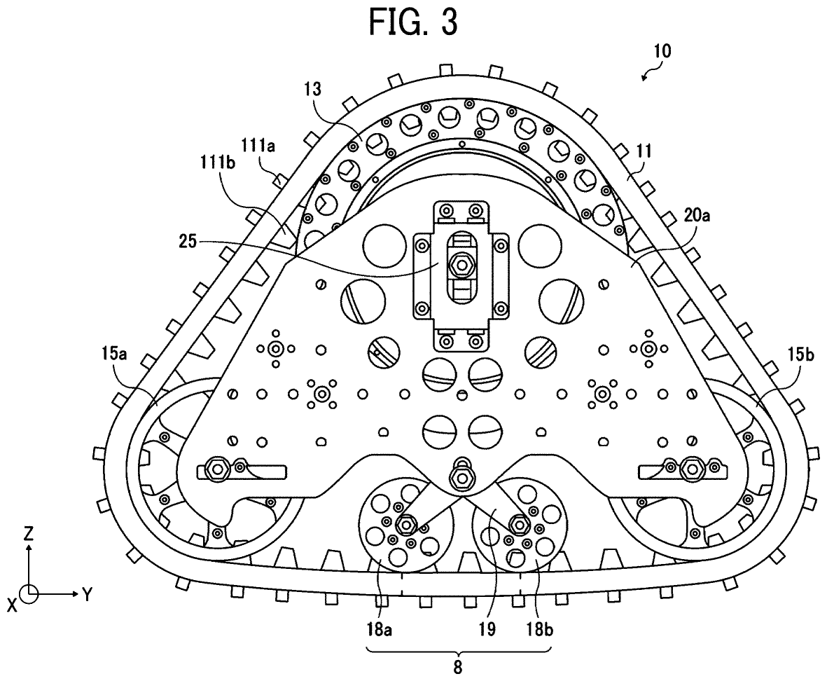

Next, referring to FIGS. 3 and 4, an overall configuration of the crawler traveling bodies 10a and 10b will be described. FIGS. 3 and 4 are views illustrating an example configuration of the crawler traveling body 10 according to the embodiment. FIGS. 3 and 4 are side views of the crawler traveling body 10 as viewed from the same direction in FIG. 1C. In this embodiment, as illustrated in FIG. 1, the traveling device 1 is provided with two crawler traveling bodies 10a and 10b. In the following description, however, the traveling bodies 10a and 10b will be collectively referred to as the crawler traveling body 10, since they have the same structure.

As illustrated in FIG. 3, the crawler traveling body 10 includes a crawler belt 11, the driving wheel 13, the rolling wheels 15a and 15b, the auxiliary mechanism 8, a side plate 20a, and a tensioner 25. The auxiliary mechanism 8 includes idlers 18a and 18b, and a link 19. FIG. 4 is a view illustrating a state in which the side plate 20ais removed from the crawler traveling body 10 illustrated in FIG. 3. The crawler traveling body 10 illustrated in FIG. 4 further includes an in-wheel motor 14, a motor shaft 141, a side plate 20b, side plate supports 27a, 27b, 27c, and 27d, rolling wheel axles 161a and 161b, and idler axles 181a and 181b, and a link shaft 191 included in the auxiliary mechanism 8.

The crawler belt 11 is also called a crawler, and is formed of metal or rubber. The crawler belt 11 is wound around the driving wheel 13 and the rolling wheels 15a and 15b. The crawler belt 11 rotates along a rotational direction of the driving wheel 13, causing the rolling wheels 15a and 15b to rotate together, so as to rotate the entire crawler traveling body 10. The crawler belt 11 has a plurality of protrusions 111a and 111b on its faces. The protrusion 111a is provided on the outer surface of the crawler belt 11, so that the traveling body 10 can stably travel even over a small obstacle such as a stone on a road surface, for example. The protrusion 111b is provided on the inner surface of the crawler belt 11, for example, to prevent a wheel, such as the driving wheel 13 or the rolling wheels 15a and 15b, from coming off from the crawler traveling body 10.

The driving wheel 13 transmits a driving force for rotating the crawler traveling body 10 to the crawler belt 11. The crawler traveling body 10 transmits a driving force (rotational force), which is transmitted to the driving wheel 13 by the in-wheel motor 14, to the rolling wheels 15a and 15b via the crawler belt 11.

The in-wheel motor 14 is built inside the driving wheel 13 and transmits a rotational force to the driving wheel 13. The in-wheel motor 14 is rotationally driven about the motor shaft 141 serving as a drive axis. The rotation axis (motor shaft 141) of the in-wheel motor 14 serves as a rotation axis (drive axis) of the driving wheel 13, and the driving wheel 13 is rotated with the rotational force of the in-wheel motor 14. The rotational force of the in-wheel motor 14 is transmitted to the crawler belt 11 as a driving force. Specifically, the in-wheel motor 14 causes the driving wheel 13 to rotate in a positive direction, causing the traveling device 1 to move forward. The in-wheel motor 14 further causes the driving wheel 13 to rotate in a negative direction, causing the traveling device 1 to move backward.

The in-wheel motor 14 is built in the driving wheel 13, such that a structure of the crawler traveling body 10 is made simple. For example, since a component such as a drive chain or a gear is not used, risks associated with a malfunction caused by such component are reduced. Further, the in-wheel motor 14, incorporated in the driving wheel 13, can generate a driving force in the vicinity of the outer periphery of the crawler traveling body 10, thus increasing the torque.

The rolling wheels 15a and 15b are rotatably attached to the crawler traveling body 10. The rolling wheels 15a and 15b rotate about the rolling wheel axles 161a and 161b, as rotation axes, by a driving force (rotational force) transmitted from the driving wheel 13 via the crawler belt 11.

In this example, the driving wheel 13, the rolling wheel 15a, and the rolling wheel 15b form a triangle when viewed from one side. The crawler belt 11 is wound around the driving wheel 13, the rolling wheel 15a and the rolling wheel 15b, such that a portion between the rolling wheel 15a and the rolling wheel 15b is to be in contact with the ground. That is, the driving wheel 13 in which the in-wheel motor 14 is built does not come into contact with the road surface. With this configuration, even when the crawler traveling body 10 travels, for example, in a puddle, the in-wheel motor 14 is not immersed in water. It is thus not necessary to provide a special waterproof mechanism for the in-wheel motor 14.

Further, as illustrated in FIG. 4, the driving wheel 13 and the rolling wheels 15a and 15b have diameters different from each other. It is usually desirable to design the layout of the traveling body in consideration of requirements, such as restriction in size or required traveling performance. Generally, the torque per unit width of a motor tends to decrease as the diameter of the motor decreases. It is thus desirable that the driving wheel incorporating the in-wheel motor has a diameter equal to or larger than the motor diameter so as to achieve the required torque performance. In view of this, the crawler traveling body 10 is designed, so that the diameter of the driving wheel 13 provided at an upper section is made larger than the diameters of the rolling wheels 15a and 15b, providing a layout that satisfies the size requirement and/or the required traveling performance of the traveling device 1 or the crawler traveling body 10. If the diameter of the rolling wheel is increased while the size of the traveling body is limited, a contact area contacting the ground is made smaller and decreasing the traveling stability. Therefore, the crawler traveling body 10 has an advantage of adopting the rolling wheels 15a and 15b having relatively small diameters in consideration of the diameter of the driving wheel 13.

In the auxiliary mechanism 8, auxiliary wheels (idlers 18a and 18b) that rotate with the crawler belt 11 are provided so as to be swingable around swing axes (link shaft 191). The auxiliary mechanism 8 is also referred to as, for example, a swing mechanism, a balance-type auxiliary mechanism, a balance-type swing mechanism, a balance-type swing wheel, or a balance-type swing rolling wheel. Further, the auxiliary mechanism 8 is provided on the bottom of the triangular shape formed by the driving wheel 13 and the rolling wheels 15a and 15b, viewed from the side.

The auxiliary mechanism 8 includes the idlers 18a and 18b, and the link 19. The idlers 18a and 18b are auxiliary wheels that are provided between the two rolling wheels 15a and 15b and that rotate with the crawler belt 11. The idlers 18a and 18b rotate about the idler axles 181a and 181b, respectively. The link 19 is a support body that supports the idler 18a and the idler 18b.

The side plates 20a and 20b support the driving wheel 13, the rolling wheels 15a and 15b, and the auxiliary mechanism 8 in the crawler traveling body 10. The crawler traveling body 10 has a both-end support structure, which supports the driving wheel 13, the rolling wheels 15a and 15b, and the auxiliary mechanism 8, with the two side plates 20a and 20b. The two side plates 20a and 20b are suspended by a plurality of side plate supports 27a, 27b, 27c, 27d. The side plates 20a and 20b support the driving wheel 13 by using the motor shaft 141, respectively.

The side plates 20a and 20b support the rolling wheels 15a and 15b by using the rolling wheel axles 161a and 161b, respectively. Further, the side plates 20a and 20b support the auxiliary mechanism 8 via the link shaft 191 of the link 19 that support the idlers 18a and 18b.

The tensioner 25 is formed of an elastic member such as a spring, and is connected to the motor shaft 141 that is a rotation axis of the in-wheel motor 14 and the driving wheel 13. The tensioner 25 is disposed, so that the driving wheel 13 is pressed against the inner side of the crawler belt 11 and applies tension to the crawler belt 11. Since the sagging of the crawler belt 11 can be corrected by the tensioner 25, the crawler traveling body 10 is able to maintain a desired level of transmission of the driving force by the crawler belt 11.

In this example, as illustrated in FIGS. 3 and 4, the crawler traveling body 10 has a substantially symmetrical structure in the front and rear in the traveling direction with the driving wheel 13 as the center. More specifically, the crawler traveling body 10 is substantially symmetrical, in a horizontal direction (in the Y direction) across the two rolling wheels 15a and 15b, while centering on the motor shaft 141 of the in-wheel motor 14. That is, the crawler traveling body 10 has a substantially symmetrical structure with respect to a perpendicular line of the motor shaft 141 of the in-wheel motor.

For example, a traveling device that travels in a narrow space frequently moves forward or backward, or makes super-pivot turns. In such case, if a shape of the crawler belt or the arrangement of the driving wheel, the rolling wheel, the tensioner, or the like, is asymmetric in the front-rear direction, driving characteristics of the traveling device may be different, when the traveling device moves forward or backward, or make super-pivot turns. With the crawler traveling body 10 having the layout (structure) that is substantially symmetrical in the front-rear direction, the traveling device 1 is able to travel with improved stability, with simplified control. Further, since the crawler traveling body 10 can be attached without being conscious of the right and left of the traveling device 1, the number of components can be reduced.

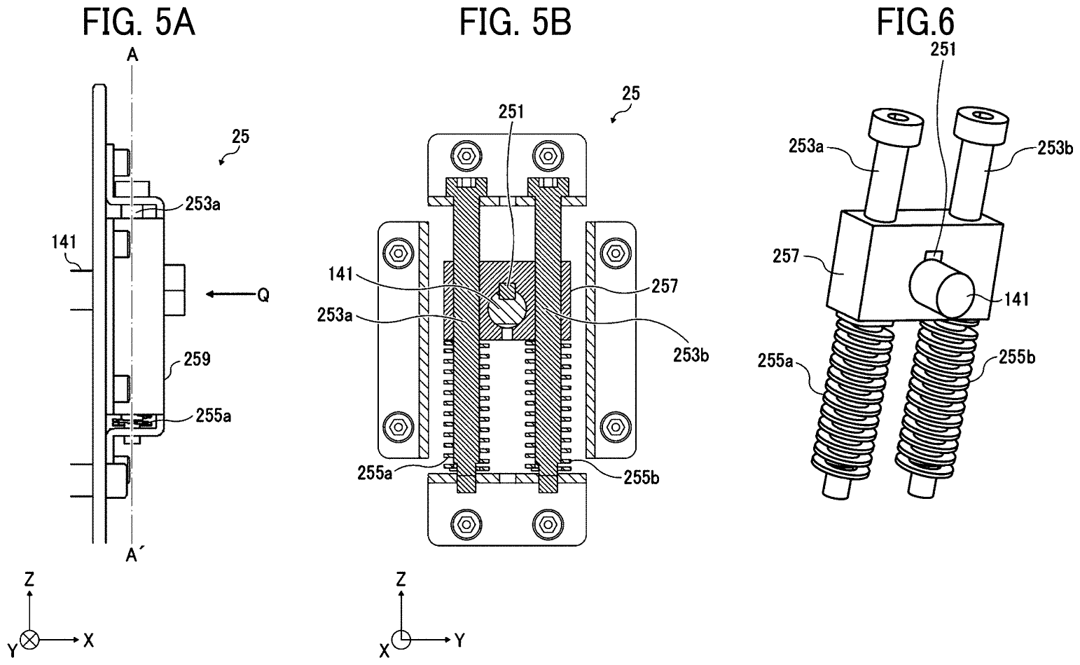

Referring next to FIGS. 5 and 6, a detailed configuration of the tensioner 25 in the crawler traveling body 10 is described according to the embodiment. FIGS. 5A and 5B are views illustrating an example configuration of the tensioner of the crawler traveling body according to the embodiment. FIG. 5A is a side view illustrating an example configuration of the tensioner attached to the crawler traveling body 10. The tensioner 25 is connected to the motor shaft 141 of the in-wheel motor 14. The tensioner 25 presses the driving wheel 13 against the crawler belt 11, to apply tension to the crawler belt 11. FIG. 5A illustrates a state in which the tensioner 25 attached to the side plate 20 is covered by an exterior cover 259. The tensioner 25 is connected to the motor shaft 141 of the in-wheel motor 14 built in the driving wheel 13.

FIG. 5B is a cross-sectional view of the tensioner 25 taken along the line A-A′ (viewed in the direction of arrow Q in FIG. 5A). FIG. 6 is a perspective view illustrating an example of a detailed configuration of the tensioner 25 included in the crawler traveling body according to the embodiment. The tensioner 25 includes a fixing portion 251, shaft portions 253a and 253b, elastic bodies 255a and 255b, and a block 257.

The fixing portion 251 is a member for fixing the positions of the driving wheel 13 and the motor shaft 141 that is a rotation axis of the in-wheel motor 14. The tensioner 25 prevents rotation of the motor shaft 141 by fixing the positional relationship between the block 257 and the motor shaft 141 using the fixing portion 251.

The shaft portions 253a and 253b are members that serve as guides for elastic deformation of the elastic bodies 255a and 255b, respectively. The elastic bodies 255a and 255b are elastic members such as springs provided along the shaft portions 253a and 253b, respectively. The elastic bodies 255a and 255b are elastically deformed in the vertical direction with the shaft portions 253a and 253b as guides.

As the motor shaft 141 passes through the block 257, the block 257 functions as a connector that connects the tensioner 25 to the motor shaft 141. The shaft portions 253a and 253b also pass through the block 257, causing the block 257 to slide in the axial direction along the shaft portions 253a and 253b. Accordingly, the tensioner 25 can operate the driving wheel 13 in the vertical direction about the motor shaft 141, in conjunction with the deformation of the elastic bodies 255a and 255b. Specifically, at the crawler traveling body 10, the motor shaft 141 is pushed up with deformation of the elastic bodies 255a and 255b. This causes the driving wheel 13 itself to be pressed against the crawler belt 11, as a tensioner, applying tension to the crawler belt 11.

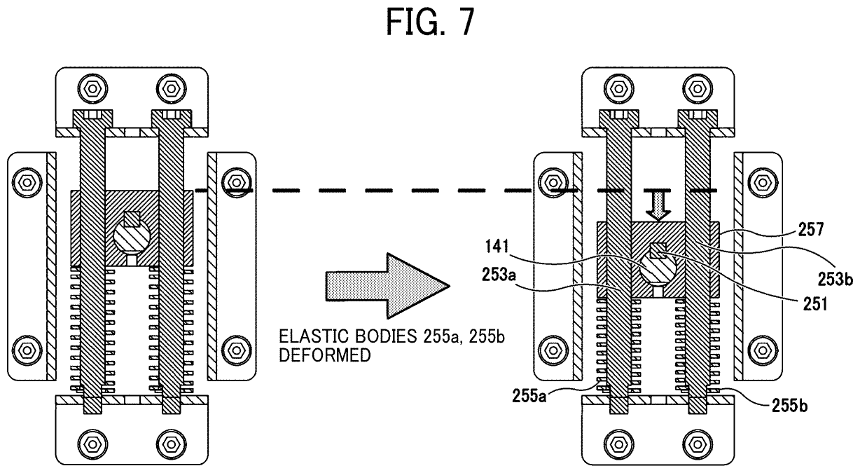

FIG. 7 is a view illustrating a state of the tensioner 25 included in the crawler traveling body according to the embodiment. As illustrated in FIG. 7, the elastic bodies 255a and 255b deform, causing expansion or contract, when pressure is applied to the driving wheel 13 from the above. The tensioner 25 illustrated on the left of FIG. 7 (similar to FIG. 5B) is in a state in which the elastic bodies 255a and 255b are stretched, and tension is applied to the crawler belt 11. The tensioner 25 illustrated on the right of FIG. 7 is in a state in which the elastic bodies 255a and 255b are contracted due to a pressure force applied from the above. For example, when the crawler belt 11 is pressed against an obstacle on a road surface during traveling, the crawler traveling body 10 can reduce damage to the crawler belt 11, as a tension applied to the crawler belt 11 is reduced due to contraction of the elastic bodies 255a and 255b.

In this example case of the triangular-formed crawler traveling body in which the driving wheel incorporating the in-wheel motor is disposed at the upper portion, in order to increase the torque of the motor, it is desirable to increase the motor diameter of the in-wheel motor. If the diameter of the motor is increased, the weight of the motor, which is generally heavy, further increases. As a result, the center of gravity of the traveling body having the driving wheel arranged at the upper portion, becomes higher, lowering the traveling stability. In the conventional crawler traveling body having a triangular shape, a tensioner is separately provided in order to prevent the wheel from coming off, but a location where the driving wheel is provided needs to be made higher in order to secure a space for providing the tensioner.

In the crawler traveling body 10 of this embodiment, the driving wheel 13 itself functions as a tensioner, as the driving wheel 13 has the rotation axis (motor shaft 141) linked to the tensioner 25. Since the driving wheel 13 can be disposed at a low portion, while eliminating the installation space of the tensioner, traveling stability improves for the crawler traveling body 10.

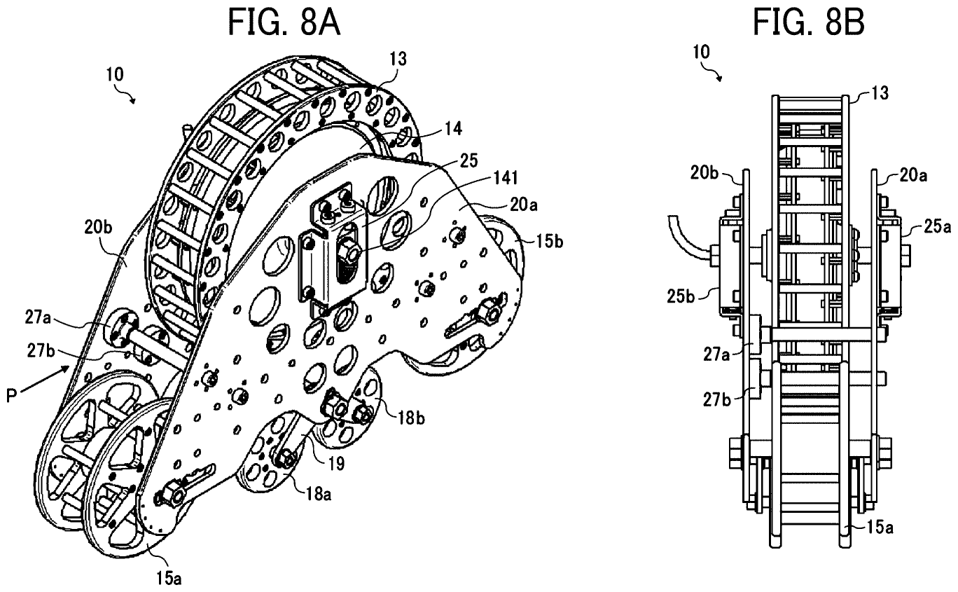

Referring now to FIGS. 8 to 10, a detailed configuration of the side plates 20a and 20b provided in the crawler traveling body 10 is described according to the embodiment. FIGS. 8 to 10 are diagrams illustrating an example configuration of a side plate included in the crawler traveling body according to the embodiment. FIG. 8A is a perspective view illustrating an outer appearance of the crawler traveling body 10 with the crawler belt 11 removed therefrom. FIG. 8B is a side view (a view seen from the direction of arrow P in FIG. 8A) illustrating a state in which the crawler belt 11 is removed from the crawler traveling body 10. The driving wheel 13, the rolling wheels 15a and 15b, and the link 19 connected with the idler 18a and the idler 18b are secured at both ends by the two side plates 20a and 20b suspended by a plurality of side plate supports 27a, 27b, 27c, and 27d (27c and 27d are illustrated in FIG. 4). The number of side plate supports is not limited to the above-described example.

As described above, the crawler traveling body 10 supports the respective axles (the motor shaft 141 of the driving wheel 13 and the wheel axles 161a and 161b of the rolling wheels 15a and 15b) at both ends, by the two side plates 20a and 20b. Since the in-wheel motor 14 built in the driving wheel 13 is large and heavy, and the tensioner 25 is connected to the motor shaft 141, it is necessary to separately provide a large arm (support body) to support the driving wheel and the rolling wheels at one end, for example, in a cantilever manner. In view of this, in the crawler traveling body 10, the driving wheel 13 and the rolling wheels 15a and 15b are supported at both ends by the side plates 20a and 20b, such that a tension is applied to the crawler belt 11 with improved stability and with a compact structure. Further, in the crawler traveling body 10, all the wheels including the idlers 18a and 18b are supported at both ends by the side plates 20a and 20b, so that the layout (structure) can be made simple and robust. Moreover, the crawler traveling body 10 can obtain high rigidity by supporting the axle of each wheel at both ends by the side plates 20a and 20b.

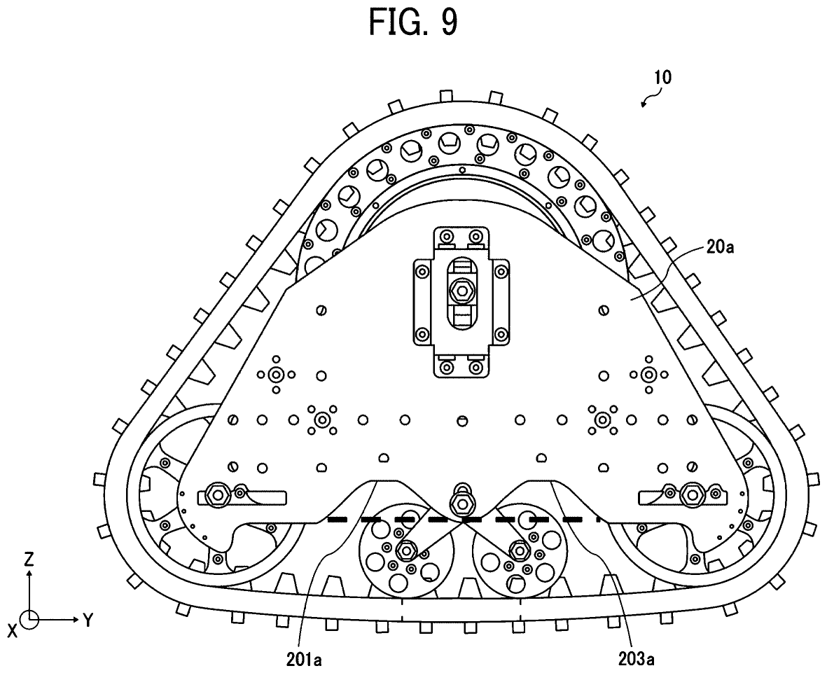

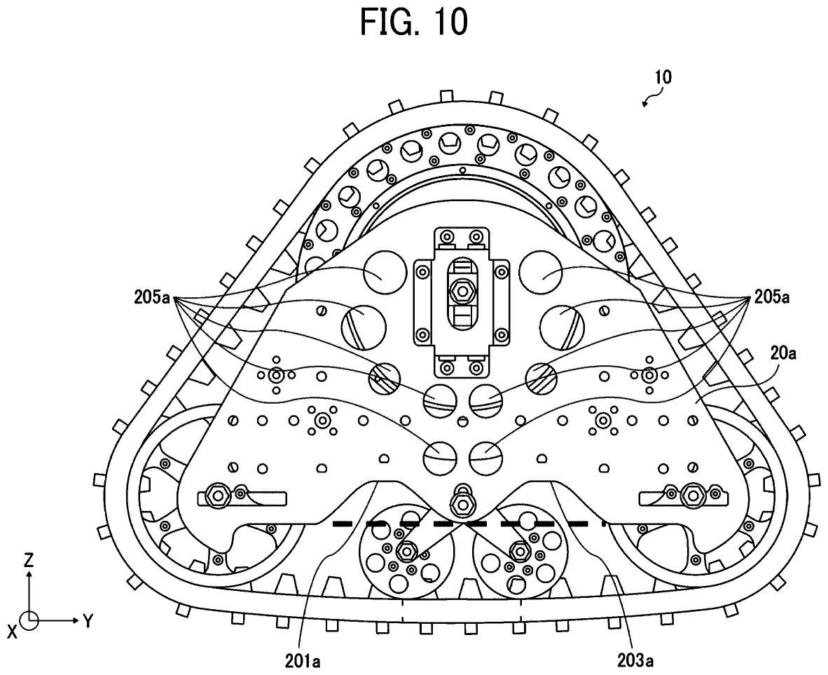

Referring to FIGS. 9 and 10, a structure of the side plates 20a and 20b provided in the crawler traveling body 10 is described according to the embodiment. Since the side plates 20a and 20b illustrated in FIG. 9 have the same structure, a structure of the side plate 20a is described referring to FIGS. 9 and 10 as an example. As illustrated in FIG. 9, the side plate 20a has cutout portions 201a and 203a, in which an area facing the side contacting the ground (bottom surface side) of the crawler belt 11 is cut out. As described above, the crawler traveling body 10 has a structure with components supported at both ends by the two side plates 20a and 20b. This may increase the number of cases where foreign matter such as branches of trees or stones are caught between the wheels and the side plates, causing the wheels to be locked. In view of this, in the crawler traveling body 10, the cutout portions 201a and 203a are provided in the side plate 20a so that the idlers 18a and 18b are not covered by the side plate 20a. This prevents foreign matter from entering between the side plate 20a and the idlers 18a and 18b. The shape and the number of the cutout portions 201a and 203a are not limited to this example. For example, the cutouts may be provided so that a portion of the rolling wheels 15a, 15b is not covered by the side plate 20a.

Further, as illustrated in FIG. 10, the side plate 20a has a plurality of side plate holes 205a to allow foreign matter entering between each wheel and the side plate 20a to be smoothly discharged. With this configuration, the crawler traveling body 10 can prevent the trouble from occurring, which may be caused by foreign matter entering between each wheel and the side plate 20a. The number or shape of the side plate holes 205a is not limited to the example illustrated in FIG. 10.

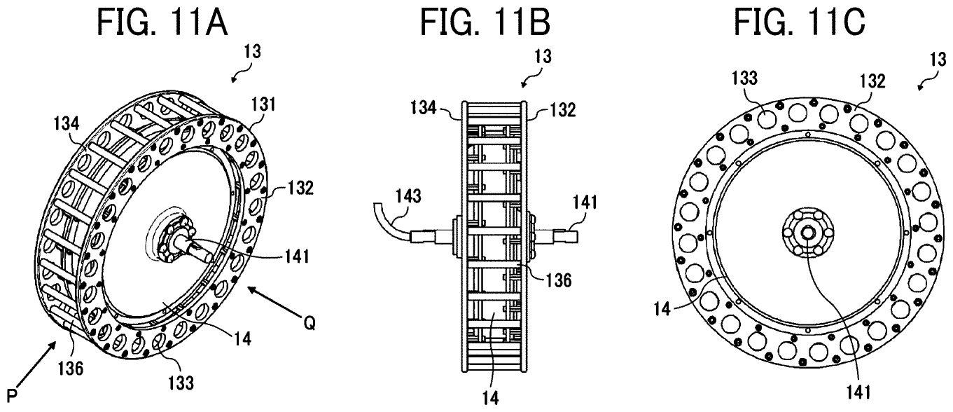

Referring now to FIGS. 11 to 13, a detailed configuration of the driving wheel 13 and the rolling wheel 15 included in the crawler traveling body 10 is described according to the embodiment. First, referring to FIGS. 11A to 11C, a detailed configuration of the driving wheel 13 provided in the crawler traveling body 10 is described. FIGS. 11A to 11C are views each illustrating an example configuration of the driving wheel 13 included in the crawler traveling body 10 according to the embodiment. FIG. 11A is a perspective view illustrating an outer appearance of the driving wheel 13. FIG. 11B is a front view (view seen from the arrow P in FIG. 11A) of the driving wheel 13 in the traveling direction.

The driving wheel 13 is implemented by a sprocket 131 having a function of transmitting the rotation of the in-wheel motor 14 to the crawler belt 11. The driving wheel 13 further includes the in-wheel motor 14, which fits into an opening of the driving wheel 13. The sprocket 131, of the driving wheel 13, rotates with the rotation of the in-wheel motor 14 about the motor shaft 141 as a rotation axis (drive axis). Further, the sprocket 131 is formed so as to connect a wheel 132 and a wheel 134 via connecting members 136. The connecting members 136 are provided between the wheels 132 and 134, along the circumferential surface of the wheels 132 and 134, so as to be spaced apart from one another at an equal distance. The protrusions 111b provided on the inner side of the crawler belt 11 rotate while entering between the adjacent connecting members 136 of the sprocket 131. With this configuration, the crawler traveling body 10 is able to transmit driving power between the crawler belt 11 and the driving wheel 13 more effectively.

The driving wheel 13 is further provided with a main body cable 143, which connects the motor shaft 141 and the main body 50. The driving wheel 13 receives power supply from a battery 1515 (see FIG. 15) provided in the main body 50 via the main body cable 143.

FIG. 11C is a side view (view seen from arrow Q in FIG. 11A) illustrating the driving wheel 13, in the traveling direction of the driving wheel 13. In the crawler traveling body, when foreign matter such as mud, earth and sand, or dust enters between the crawler belt and the traveling body, there is a possibility that rotation of the driving wheel is locked or the crawler belt is disengaged. The wheel 132 of the driving wheel 13 has a plurality of wheel holes 133 to prevent the entry of foreign matter. With this structure, foreign matter that has entered between the driving wheel 13 and the crawler belt 11, or between the driving wheel 13 and the sprocket 131 can be smoothly discharged. The number or shape of the wheel holes 133 is not limited to the example illustrated in FIG. 11C. The wheel 134 has a configuration similar to that of the wheel 132.

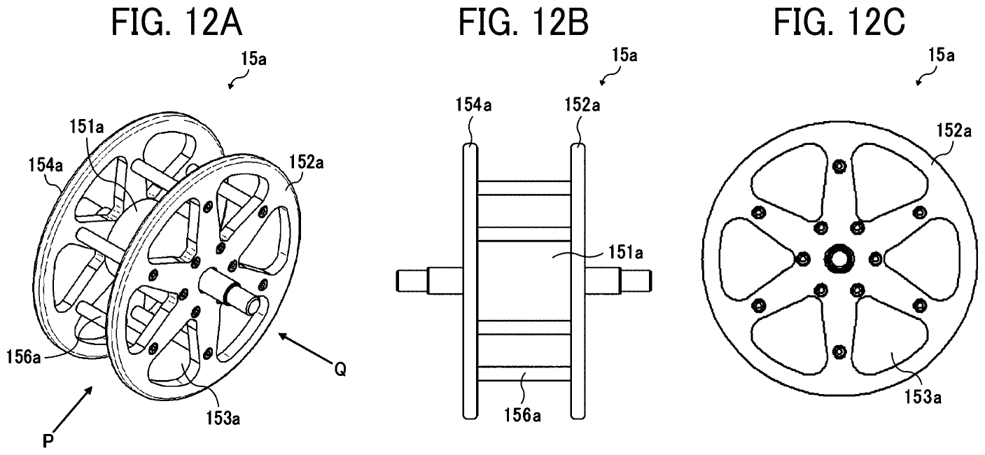

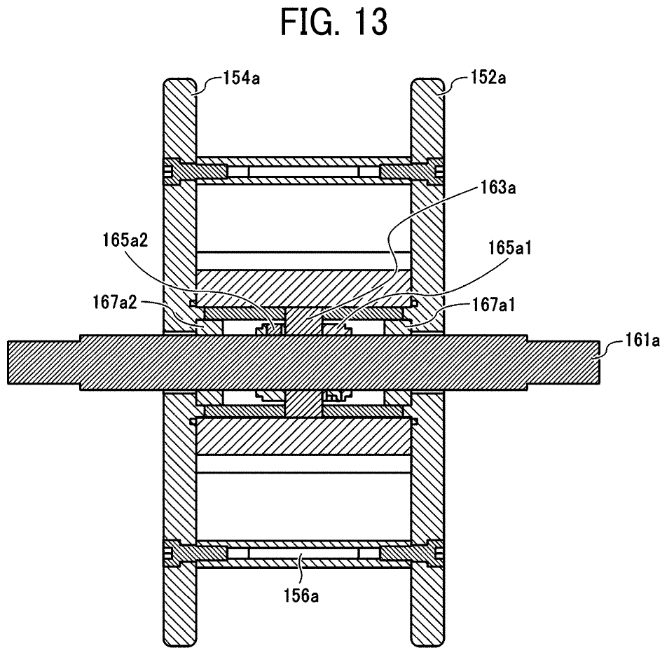

Referring now to FIGS. 12 and 13, a configuration of the rolling wheels 15a and 15b is described according to the embodiment. Since the configuration of the rolling wheels 15a and 15b are the same, the configuration of the rolling wheel 15a is described in FIGS. 12 and 13 as an example. FIGS. 12A to 12C are views illustrating an example configuration of a rolling wheel included in the crawler traveling body according to the embodiment. FIG. 12A is a perspective view illustrating an outer appearance of the rolling wheel 15a. FIG. 12B is a front view (view seen from the arrow P in FIG. 12A) of the rolling wheel 15a in the traveling direction.

The rolling wheel 15a is formed so as to connect a wheel 152a and a wheel 154a via an axle 151a. The rolling wheel 15a is provided with connecting members 156a, which are provided between the wheel 152a and the wheel 154a, along the circumferential surface of the wheels 152a and 154a, so as to be spaced apart from one another at an equal distance. The protrusions 111b provided on the inner side of the crawler belt 11 rotate while entering between the adjacent connecting members 156a. With this configuration, the crawler traveling body 10 is able to prevent the crawler belt 11 from coming off, or prevent the rolling wheel 15a from coming off from the crawler belt 11.

FIG. 12C is a side view (view seen from arrow Q in FIG. 12A) illustrating the rolling wheel 15a, in the traveling direction of the rolling wheel. The wheel 152a of the rolling wheel 15a has a plurality of wheel holes 153a in order to prevent foreign matter from entering, as in the case of the driving wheel 13. With this structure, foreign matter that has entered between the rolling wheel 15a and the crawler belt 11 can be smoothly discharged. The number or shape of the wheel holes 153a is not limited to the example illustrated in FIG. 12C. The wheel 154a has a configuration similar to that of the wheel 152a.

Referring now to FIG. 13, a cross-sectional structure of the axle 151a in the traveling direction (P direction) of the rolling wheel 15a is described according to the embodiment. FIG. 13 is a view illustrating an example internal structure of an axle of a rolling wheel included in the crawler traveling body according to the embodiment. In addition to the configuration illustrated in FIG. 12, the rolling wheel 15a includes, as a part of the axle 151a, a rolling wheel axle 161a serving as a rotation axis of the rolling wheel, a bearing 163a, set collars 165a1 and 165a2, and oil seals 167a1 and 167a2.

The rolling wheel 15a has, as a part of the axle 151a, one bearing 163a in a central portion of the rolling wheel axle 161a. Thus, the crawler traveling body 10 has a configuration in which only one bearing 163a is provided, so that the number of components can be reduced and cost reduction is achieved.

The rolling wheel 15a further includes, as a part of the axle 151a, the two set collars 165a1 and 165a2 so as to sandwich the bearing 163a disposed in the central portion of the rolling wheel axles 161a, thus, serving as a pressing member of the bearing 163a. With this configuration, the crawler traveling body 10 can easily offset the wheels 152a and 154a with respect to the rolling wheel axle 161a.

Further, the rolling wheel 15a has the oil seals 167a1 and 167a2 on the inner sides of the wheels 152a and 154a, respectively. Thus, the crawler traveling body 10 can protect the bearing 163a of the axle 151a from foreign matter such as water or dust entering from the outside.

Referring now to FIGS. 14 to 16, a configuration of the auxiliary mechanism 8 provided in the crawler traveling body 10 is described according to the embodiment. FIG. 14 is a diagram illustrating an example configuration of an auxiliary mechanism included in the crawler traveling body according to the embodiment. As illustrated in FIG. 14, the auxiliary mechanism 8 includes the link 19 and the two idlers 18a and 18b connected by the link 19. The link 19 is a support that supports the plurality of idlers 18. The idlers 18a and 18b are connected by a both-end support structure in which two link plates 192a and 192b are suspended by the link shaft 191. Further, as illustrated in FIG. 3, the auxiliary mechanism 8 is supported by the side plates 20a and 20b, using the two link plates 192a and 192b and the link shaft 191 of the link 19. The idlers 18a and 18b are examples of auxiliary wheel. The link 19 is an example of a connector. The link shaft 191 is an example of a swing axis. The link plates 192a and 192b are an example of a swing portion.

Referring now to FIG. 15, a cross-sectional structure of the link 19 in the traveling direction (P direction) of the auxiliary mechanism 8 is described according to the embodiment. FIG. 15 is a diagram illustrating an example internal structure of the link included in the crawler traveling body according to the embodiment. The link 19 includes set collars 193a and 193b, and push members 195a and 195b, in addition to the configuration illustrated in FIG. 14.

The set collars 193a and 193b are provided on the inner sides of the link plates 192a and 192b of the link 19, to press the link plates 192a and 192b, respectively. Thus, the crawler traveling body 10 can be easily offset with respect to the link shaft 191 by fixing the positions of the link plates 192a and 192b with the set collars 193a and 193b, respectively.

The link 19 further includes push members 195a and 195b such as push nuts at the joint portions between the link shaft 191 and the link plates 192a and 192b. Thus, in the crawler traveling body 10, the link plates 192a and 192b can smoothly swing and rotate with respect to the link shaft 191.

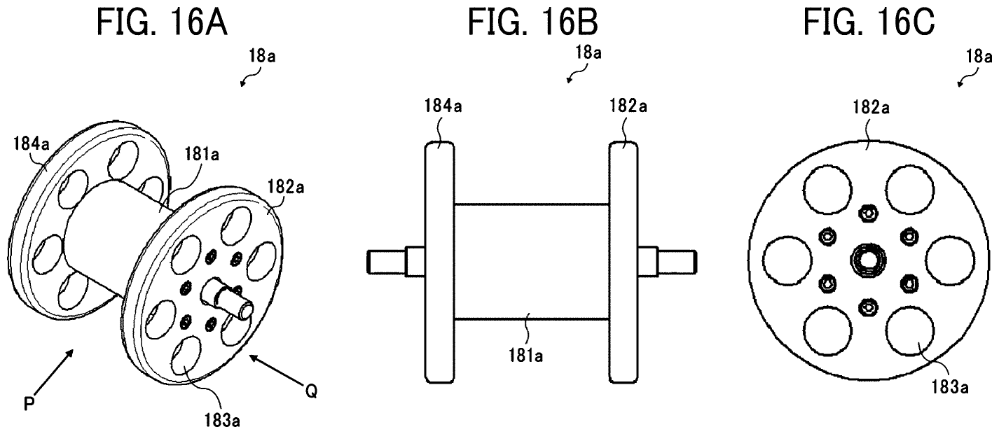

FIGS. 16A to 16C are views each illustrating an example configuration of an idler included in the crawler traveling body according to the embodiment. Since the structures of the idlers 18a and 18b illustrated in FIG. 14 are the same, the structure of the idler 18a is described referring to FIG. 16 as an example. FIG. 16A is a perspective view of an outer appearance of the idler 18a. FIG. 16B is a front view (a view seen from the arrow P in FIG. 16A) of the idler 18ain the traveling direction of the idler 18a. As illustrated in FIGS. 16A and 16B, the idler 18a is formed so as to connect a wheel 182a and a wheel 184a via an idler axle 181a.

FIG. 16C is a side view (a view seen from the arrow Q in FIG. 16A) of the idler 18a in the traveling direction of the idler 18a. As illustrated in FIG. 16C, the wheel 182a of the idler 18a has a plurality of wheel holes 183a so as to prevent foreign matter from entering, similarly to the case of the rolling wheel 15a. With this structure, foreign matter that has entered between the idler 18a and the crawler belt 11 can be smoothly discharged. The number or shape of the wheel holes 183a is not limited to the example illustrated in FIG. 16C. The wheel 184a has a configuration similar to that of the wheel 182a.

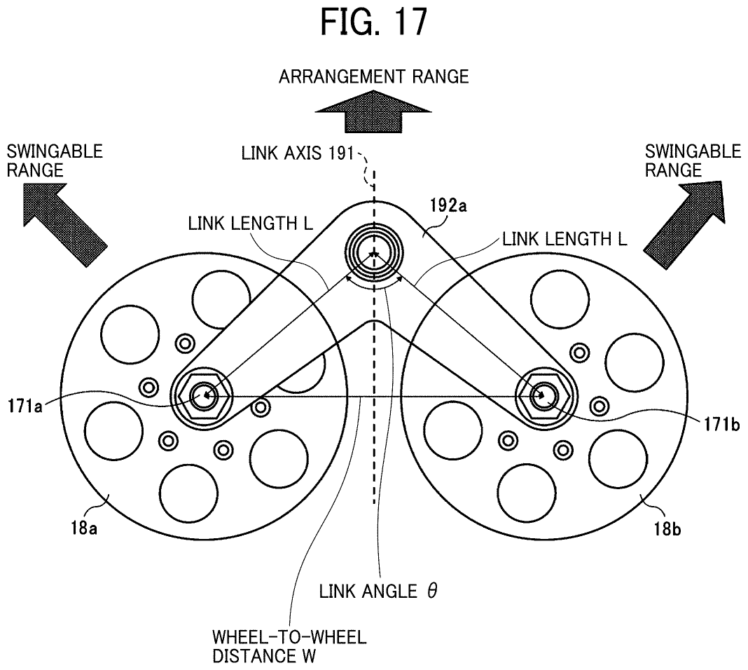

The idler 18a has a cross-sectional structure similar to that of the rolling wheel 15a illustrated in FIG. 13. For example, in addition to the configuration illustrated in FIG. 16B, the idler 18a includes, as a part of the idler axle 181a, a wheel axle 171a (see FIG. 17) serving as a rotation axis of the idler 18a, a bearing, a set collar, and an oil seal. The wheel axle 171a(see FIG. 17), the bearing, the set collar, and the oil seal have the same configurations as those of the rolling wheel axle 161a, the bearing 163a, the set collars 165a1 and 165a2, and the oil seals 167a1 and 167a2 in the rolling wheel 15a illustrated in FIG. 13, respectively, and thus description thereof will be omitted.

In this example, the diameters of the wheel holes respectively provided in the idler 18, the driving wheel 13, and the rolling wheels 15a and 15b are preferably φ 15 or more, for example, to allow smooth discharge of various foreign substances. The same applies to the side plate holes 205a and 205b provided in the side plates 20a and 20b.

In this example, in the crawler traveling body 10, the crawler belt 11 is driven by the rotation of the driving wheel 13 incorporating the in-wheel motor 14. The rolling wheels 15a and 15b are rotated by the transmission of a rotational force of the crawler belt 11. Further, the rolling wheels 15a and 15b are guided by the protrusions 111b provided on the inner side of the crawler belt 11, so as to rotate with the movement of the crawler belt 11. At this time, when the widths of the rolling wheel 15a and the rolling wheel 15b are wide, there is a possibility that the crawler belt 11 may come off from the rolling wheel 15a or the rolling wheel 15b. The crawler traveling body 10 is provided with the auxiliary mechanism 8 which comes into contact with the crawler belt 11 between the rolling wheel 15a and the rolling wheel 15b, so that derailment of the crawler belt 11 can be prevented. The crawler traveling body 10 is further provided with the idlers 18a and 18b that is on a surface facing the ground, in addition to the rolling wheels 15a and 15b, the load is distributed, thus, reducing the risk of occurrence of a failure.

Further, in the crawler traveling body 10, when the contact area contacting the ground increases, the resistance to the road surface increases, thus, improving traveling stability. On the other hand, in the crawler traveling body 10, when the contact area contacting the ground decreases, the resistance to the road surface decreases, but the turning performance during traveling improves. In particular, it becomes easier for the traveling device 1 to make the super pivot turns. In order to utilize such a feature, the crawler traveling body 10 can adjust the height of the contact position of the idlers 18a and 18b with the crawler belt 11 in the vertical direction, through adjusting the height of the auxiliary mechanism 8 according to specific use application or use environment.

Specifically, in the crawler traveling body 10, for example, when the traveling device 1 is stopped, the height of the link 19 which is statically fixed is changed by an operator, so that the heights of the idlers 18a and 18b are adjusted to be raised or lowered. Further, the crawler traveling body 10 may be configured such that the height of the link 19 can be dynamically changed in response to a control signal from a posture control motor driver, for example. In such case, the traveling device 1 adjusts the heights of the links 19 of the two crawler traveling bodies 10a and 10b by driving the posture control motors based on the control signals transmitted from the posture control motor drivers. The traveling device 1 controls the height adjustment of the link 19 in accordance with, for example, a state of a road surface, a traveling speed, etc.

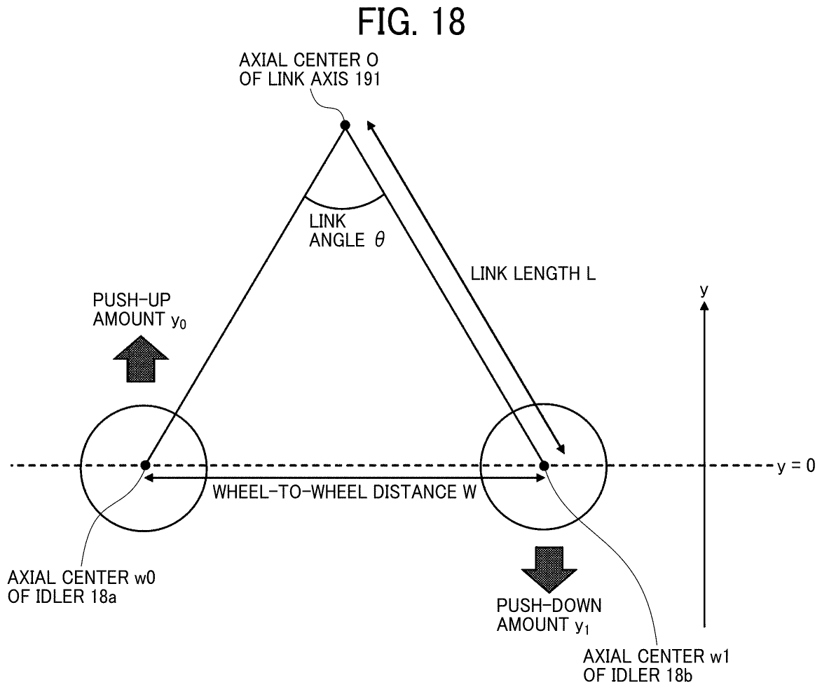

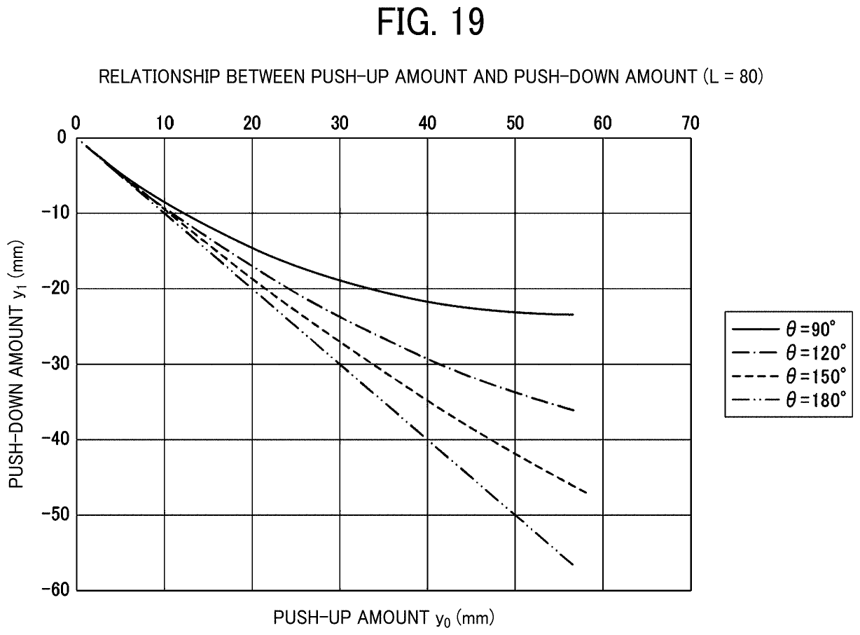

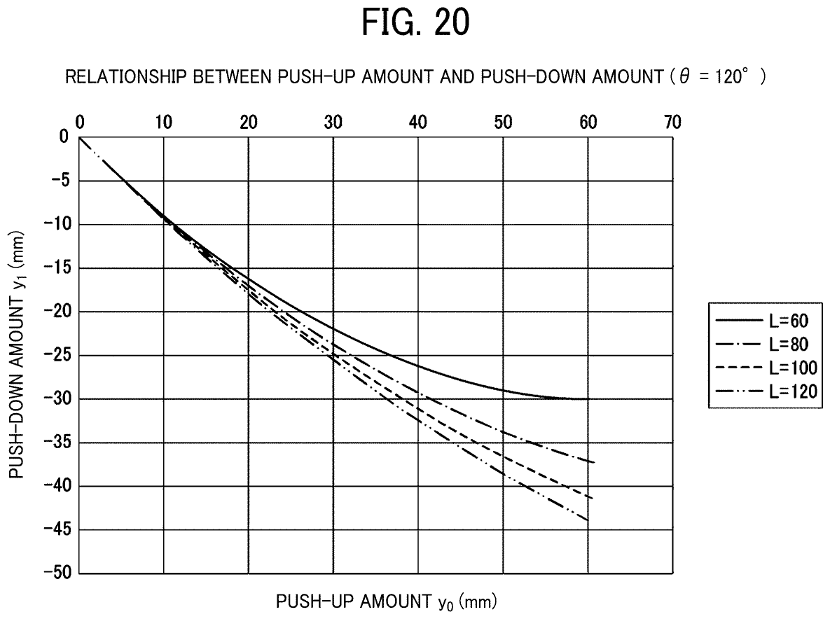

Referring now to FIGS. 17 to 22, a detailed configuration of the auxiliary mechanism 8 is described according to the embodiment. FIGS. 17 and 18 are views for explaining an example detailed configuration of the auxiliary mechanism included in the crawler traveling body according to the embodiment. FIG. 19 is a graph illustrating an example relationship between a push-up amount and a push-down amount in the auxiliary mechanism provided in the crawler traveling body according to the embodiment. FIG. 20 is a graph illustrating another example relationship between a push-up amount and a push-down amount in the auxiliary mechanism provided in the crawler traveling body according to the embodiment.

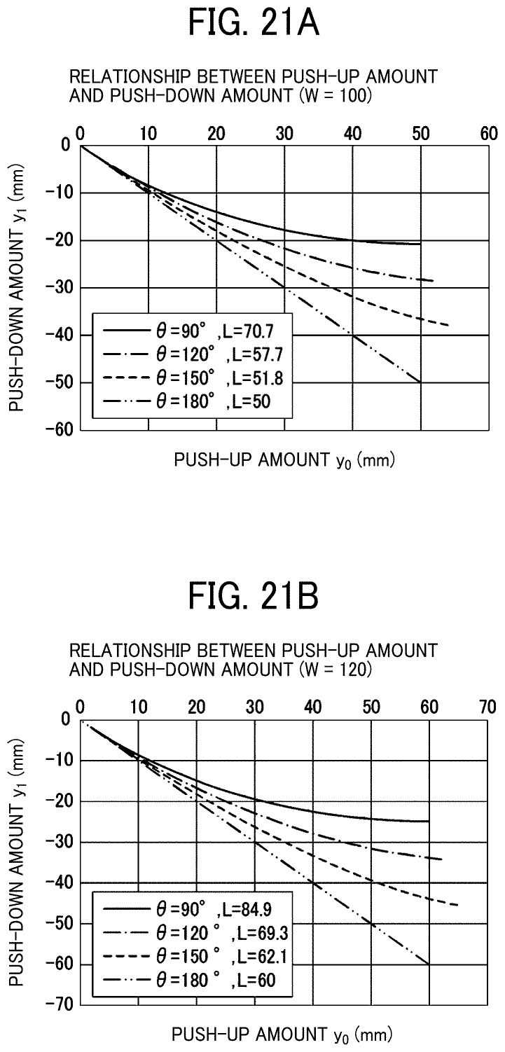

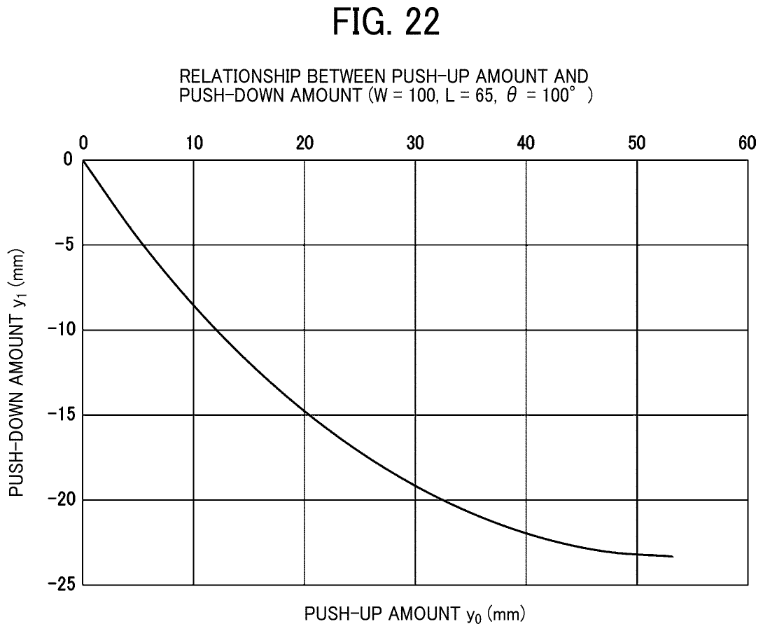

FIG. 21 is a graph illustrating another relationship between a push-up amount and a push-down amount in the auxiliary mechanism provided in the crawler traveling body according to the embodiment. FIG. 22 is a graph illustrating another example relationship between a push-up amount and a push-down amount in the auxiliary mechanism provided in the crawler traveling body according to the embodiment.

FIG. 17 is a side view (view seen from the arrow Q in FIG. 16A) of the auxiliary mechanism 8 in the traveling direction. The auxiliary mechanism 8 connects the two idlers 18a and 18b to the link 19 via the link plate 192a. Further, the auxiliary mechanism 8 connects the idlers 18a and 18b such that they can swing about link shaft 191 included in the link 19. The auxiliary mechanism 8 has a shape symmetrical about the link shaft 191 in the front-rear direction.

In the crawler traveling body 10, each member is to be installed in a limited space. Therefore, a range in which the auxiliary mechanism 8 can be disposed and a range in which the auxiliary mechanism 8 can swing are limited by the positional relationship with other members. Specifically, since the driving wheel 13 is disposed above the auxiliary mechanism 8, the range in which the auxiliary mechanism 8 can be disposed is restricted by the installation position and the size of the driving wheel 13, which depends on the size of the crawler traveling body 10. Further, since the rolling wheels 15a and 15b are disposed in front of and behind the auxiliary mechanism 8, the swingable range of the auxiliary mechanism 8 is restricted by the installation positions and sizes of the rolling wheels 15a and 15b, which depends on the size of the crawler traveling body 10.

In the case where the crawler traveling body 10 is provided in a limited space range of the auxiliary mechanism 8 in order to increase the degree of contact with the ground during traveling on the irregular ground, for example, it is desirable to optimally design a link length, an inter-wheel (wheel-to-wheel) distance and a link angle as illustrated in FIG. 17. FIG. 18 schematically illustrates the side view of the auxiliary mechanism 8 illustrated in FIG. 17. As illustrated in FIG. 18, the link length L is a length of a line segment (side) connecting the link shaft 191 (axial center O) and the wheel axles 171a and 171b (axial centers w0 and w1) of the idlers 18a and 18b. Further, the wheel-to-wheel distance W is a length of a line segment (side) connecting the wheel axle 171a (axial center w0) and the wheel axle 171b (axial center w1). Further, the link angle θ is an angle formed by two line segments (sides) having the link length L. In this example, a line segment (side) connecting the wheel axle 171a (axial center w0) of the idler 18a and the link shaft 191 (axial center O) is an example of a first side. A line segment (side) connecting the wheel axle 171b (axial center w1) of the idler 18b and the link shaft 191 (axial center O) is an example of a second side.

In the crawler traveling body, for example, a part of the crawler belt may float without being grounded due to unevenness of a traveling road surface such as an irregular ground. Therefore, in the crawler traveling body 10, it is preferable that the idlers 18a and 18b move independently of each other so as to follow the traveling road surface. The crawler traveling body 10 has a configuration in which when one idler 18 (idler 18a) is pushed up, the other idler (for example, idler 18b) is pushed down due to the swing operation by the auxiliary mechanism 8.

For example, as illustrated in FIG. 18, the vertical direction of the auxiliary mechanism 8 is defined as the y-axis. The positions of the wheel axles 171a and 171b (axial centers w0 and w1) when the auxiliary mechanism 8 is in the horizontal state are defined as y=0. Further, a push-up amount by which the idler 18a is pushed up in the vertical direction is defined as y0. A push-down amount by which the idler 18b is pushed down in the vertical direction is defined as y1.

In the auxiliary mechanism 8, the respective idlers are independently moved. Even when the idler 18a is pushed up, the push-down amount of the other idler 18b is made as small as possible, so that the crawler traveling body 10 can stably travel. That is, the auxiliary mechanism 8 has a configuration in which the push-up amount y0 of one idler 18a in the vertical direction is larger than the push-down amount y1 of the other idler 18b in the vertical direction. With such a configuration, in the crawler traveling body 10, the auxiliary mechanism 8 can increase the contact area contacting the ground even when a size is restricted.

A desired design of the auxiliary mechanism 8 is described according to the embodiment. The link length L and the link angle θ of the auxiliary mechanism 8 are determined by the arrangeable range, the swingable range, the wheel-to-wheel distance W, and the wheel diameters of the idlers 18a and 18b, as illustrated in FIG. 17. First, the relationship between the push-up amount y0 and the push-down amount y1 when one of the link length L and the link angle θ is fixed and the other is changed will be described with reference to FIGS. 19 and 20.

FIG. 19 illustrates the relationship between the push-up amount y0 and the push-down amount y1 when the link length L is fixed at 80 mm (L=80) and the link angle θ is set at 90°, 120°, 150°, and 180°. As illustrated in FIG. 19, the influence of the push-down amount y1 on the push-up amount y0 becomes smaller as the link angle θ becomes smaller.

FIG. 20 illustrates the relationship between the push-up amount y0 and the push-down amount y1 when the link angle θ is fixed at 120° (0=120°) and the link length L is set to 60 mm, 80 mm, 100 mm, and 120 mm. As illustrated in FIG. 20, the influence of the push-down amount y1 on the push-up amount y0 becomes smaller as the link length L becomes shorter. Therefore, in the auxiliary mechanism 8, the influence of the push-down amount y1 on the push-up amount y0 is reduced as the link angle θ and the link length L become smaller.

Next, with reference to FIGS. 21A and 21B, the relationship between the push-up amount y0 and the push-down amount y1, when the value of the wheel-to-wheel distance W is fixed and the values of the link length L and the link angle θ are changed, is described according to the embodiment. When any two values of the link length L, the wheel-to-wheel distance W, and the link angle θ are determined, the remaining one value is uniquely determined. That is, when the wheel-to-wheel distance W is constant, the values of the link length L and the link angle θ have a relationship, such that when one is determined, the other is also determined.

FIG. 21A illustrates the relationship between the push-up amount y0 and the push-down amount y1 when the wheel-to-wheel distance W is fixed at 100 mm (W=100) and the link angles θ are set at 90°, 120°, 150°, and 180°, respectively. In the case of FIG. 21A, the link lengths L when θ=90°, 120°, 150°, and 180° are 70.7 mm, 57.7 mm, 51.8 mm, and 50 mm, respectively. FIG. 21B illustrates the relationship between the push-up amount y0 and the push-down amount y1 when the wheel-to-wheel distance W is fixed at 120 mm (W=120) and the link angles θ are set at 90°, 120°, 150°, and 180°, respectively. In the case of FIG. 21B, the link lengths L when θ=90°, 120°, 150°, and 180° are 84.9 mm, 69.3 mm, 62.1 mm, and 60 mm, respectively.

As illustrated in FIGS. 21A and 21B, the influence of the push-down amount y1 on the push-up amount y0 is smaller when the link angle θ is made smaller than when the link length L is made shorter. Therefore, by designing the auxiliary mechanism 8 so as to make the link angle θ smaller in consideration of the size restriction of the crawler traveling body 10, it is possible to reduce the influence of the push-down (sinking) of one idler 18 on the push-up (projection) of the other idler 18.

In this example, a case where the push-up amount y0 of one idler 18a is ½ of the wheel-to-wheel distance W and the push-down amount y1 of the other idler 18b is ¼ or less of the wheel-to-wheel distance W is taken as an example of a preferable relationship between the push-up amount y0 and the push-down amount y1 for improving the ground contact stability of the crawler traveling body 10. That is, when the push-down amount y1 is equal to or less than half of the push-up amount y0, the crawler traveling body 10 can further improve the ground contact stability (ground contact area) using the auxiliary mechanism 8.

When the boundary values of the link angle θ and the link length L that satisfy the condition of y1≤y0/2 are calculated using the definition illustrated in FIG. 18, the boundary values do not depend on the link length L, and the link angle θ≤105° is obtained. In the case of θ<90°, when one idler 18a is pushed up by W/2, the other idler 18b may exceed the link shaft 191. Therefore, the auxiliary mechanism 8 can further improve the ground contact stability of the crawler traveling body 10 by setting the link angle θ in a range of an angle larger than 90°, but equal to or smaller than 105° (90°<θ≤105°).

Referring to FIG. 22, an example of the arrangement of the auxiliary mechanism 8 that satisfies y1≤W/4 is described according to the embodiment. FIG. 22 illustrates the relationship between the push-up amount y0 and the push-down amount y1 when the wheel-to-wheel distance W is set to 100 mm (W=100), the link length L is set to 65 mm (L=65), and the link angle θ is set to 100° (θ=100°). As illustrated in FIG. 22, the auxiliary mechanism 8 can set the push-down amount y1 to W/4 or less by setting the wheel-to-wheel distance W, the link angle θ, and the link length L as described above.

Although the above description has been made from the viewpoint of the influence of the push-down amount on the push-up amount, the same description also applies to the viewpoint of the influence of the push-up amount y0 of the idler 18b on the push-down amount y1 of the idler 18a, when the idler 18a is pushed down.

The above-described crawler traveling body has, for example, a size of about the shoulder width of a person, such that the crawler traveling body may be implemented by a mobile object that can be easily pushed and moved by a single person. When such a small-sized crawler traveling body is caused to travel in a place where safety is ensured, there are many cases where a brake function is unnecessary.

However, when traveling or stopping on a slope is required or traveling at high speed is accompanied, a brake function may be required for safety. The braking function is now described below.

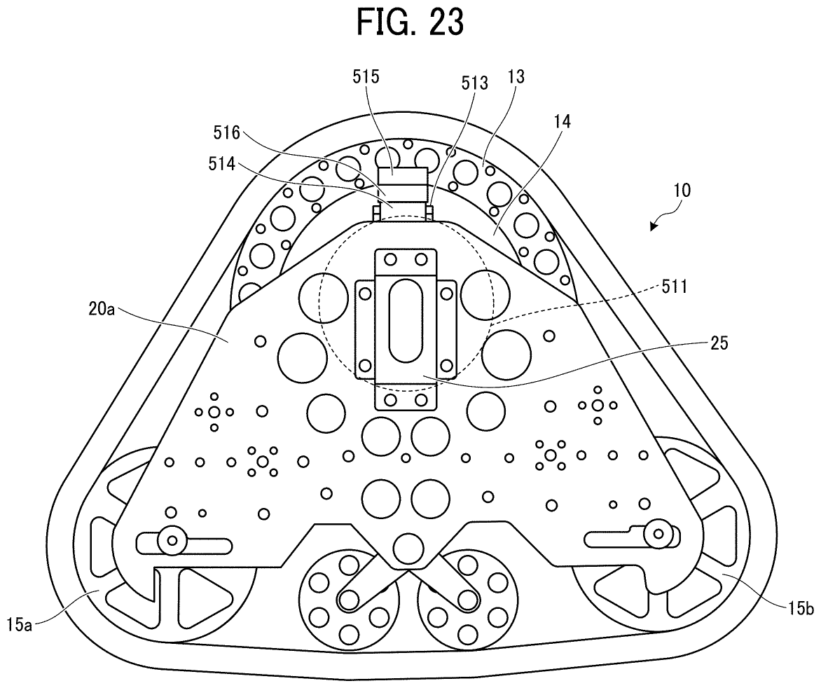

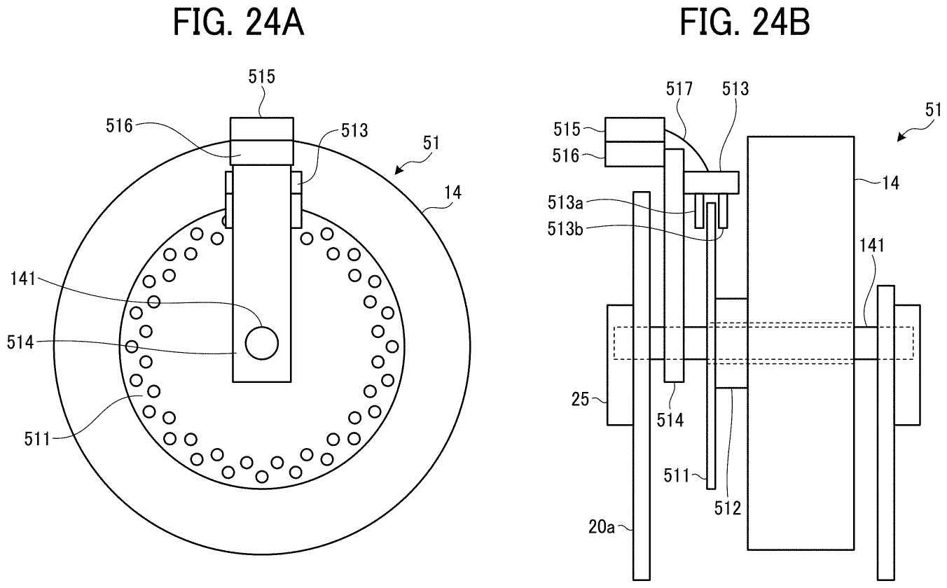

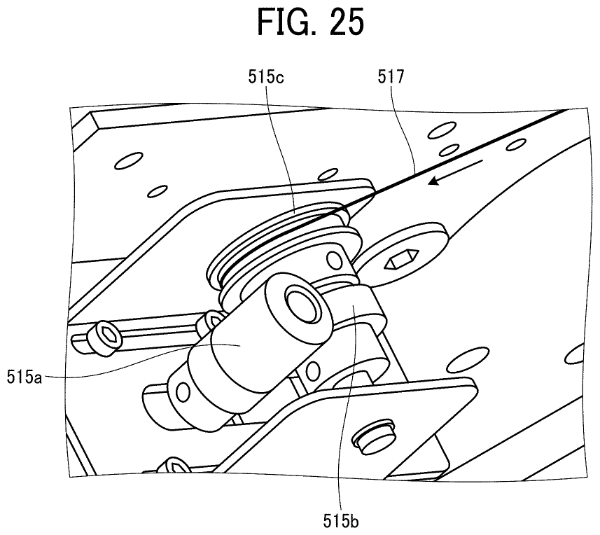

Referring now to FIGS. 23 and 24, an example configuration of the disc brake 51 included in the traveling device 1 is described according to the embodiment. FIG. 23 is a side view (view seen from the arrow Q of FIG. 1A) of the crawler traveling body 10 according to the embodiment. FIGS. 24A and 24B are each a diagram illustrating an example configuration of a disc brake included in the traveling device according to the embodiment. FIG. 24A is a side view of the disc brake 51 (view seen from the direction of arrow Q of FIG. 1A). FIG. 24B is a front view of the disc brake 51 (view seen from the direction of arrow P of FIG. 1A). In FIG. 24A, the side plate 20a is omitted.

In the present embodiment, the traveling device 1 includes the disc brake 51 that controls braking function of the crawler traveling body 10. As illustrated in FIG. 24, the disc brake 51 includes a disc 511, a disc connector 512, a brake caliper 513, a brake holder 514, a gear box 515, and a motor 516.

The disc 511 has a disc shape, and is connected (coupled) to the driving wheel 13 (an example of a wheel) by the disc connector 512 described later. The disc connector 512 is an example of a disk connection section that connects the driving wheel 13 and the disc 511 and rotates the driving wheel 13 and the disc 511 together. In the present embodiment, the disc connector 512 is attached to the driving wheel 13 and the disc 511.

The brake caliper 513 is an example of a brake caliper that sandwiches the disc 511 between two brake pads 513a and 513b. The brake caliper 513 controls the rotation of the disc 511, for example, to stop the rotation of the disc 511.

The brake holder 514 is an example of a brake holding section that holds (supports) the brake caliper 513. In the present embodiment, the brake holder 514 is attached to the motor shaft 141, which is an axle of the driving wheel 13 that is provided, in a manner swingable, on the side plates 20a and 20b (an example of the main body) of the crawler traveling body 10.

When the driving wheel 13 swings with the disc brake 51, even if the brake caliper 513 is attached to the side plate 20a, an appropriate position of the disc 511 may not be secured by the brake pads 513a and 513b. In view of this, in this embodiment, the brake caliper 513 is attached to the motor shaft 141 by the brake holder 514, so that the disc 511 and the brake caliper 513 do not swing. Accordingly, an appropriate position of the disc 511 can be secured by the brake pads 513a and 513b that sandwich the disc 511 therebetween. Specifically, the position of the brake holder 514 is determined with respect to the motor shaft 141, in the axial direction and the radial direction of the motor shaft 141. In the present embodiment, the brake holder 514 holds (supports) the gear box 515 and the motor 516 in addition to the brake caliper 513.

The motor 516 is an example of a motor that opens or closes the brake pads 513a and 513b. In particular, the motor 516 transmits driving force to the brake caliper 513 to open or close the brake pads 513a and 513b. The gear box 515 transmits driving force, from the motor 516, to the brake caliper 513. In this embodiment, the gear box 515 transmits driving force from the motor 516 to the brake caliper 513 via the control line 517.

In this example, the control line 517 is a wire for controlling a space between the brake pads 513a and 513b. The motor 516 controls the space between the brake pads 513a and 513b by pulling the control line 517 in the direction of arrow (FIG. 25) or loosening the control line 517 via the gear box 515.

Referring next to FIG. 25, an example of a basic inner structure of the gear box 515 in the disc brake 51 of the traveling device 1 is described according to the embodiment. FIG. 25 is a diagram illustrating an example of a basic structure of the gear box in the disc brake of the traveling device 1 according to the embodiment.

In the present embodiment, as illustrated in FIG. 25, the gear box 515 may be a worm gear that transmits power from the motor 516 to the brake pads 513a and 513b to control the degree of opening and closing of the brake pads 513a and 513b. In a case where the power from the motor 516 is transmitted to the brake caliper 513 by a normal gear, when the motor 516 is transitioned to a non-excited state (a state in which a power source of the motor 516 is turned off to reduce heat generation of the motor 516, contributing to energy saving), the disc brake 51 is in a free state such that control of the traveling device 1 is not performed. In view of this, in the present embodiment, a worm gear is provided at a portion that transmits the power of the motor 516 to the brake caliper 513, such that control of the traveling device 1 is made possible even when the motor 516 is in the non-excited state.

In particular, the gear box 515 includes a worm 515a, a worm wheel 515b, and a pulley 515c, as illustrated in FIG. 25. The worm 515a is connected to a motor shaft of the motor 516. The worm wheel 515b rotates in contact with the worm 515a.

The pulley 515c is connected to the worm wheel 515b, rotates in conjunction with the worm wheel 515b, and transmits driving force from the motor 516 to the control line 517. Accordingly, the pulley 515c pulls the control line 517 or loosens the control line 517.

In the present embodiment, the tension of the control line 517 can be maintained by the self-locking mechanism of the worm gear included in the gear box 515 even when the motor 516 is in the non-excited state (power off). Therefore, when the traveling device 1 is parked on a slope or the like, even if the power supply of the motor 516 is turned off, the state in which the brake is applied can be maintained.

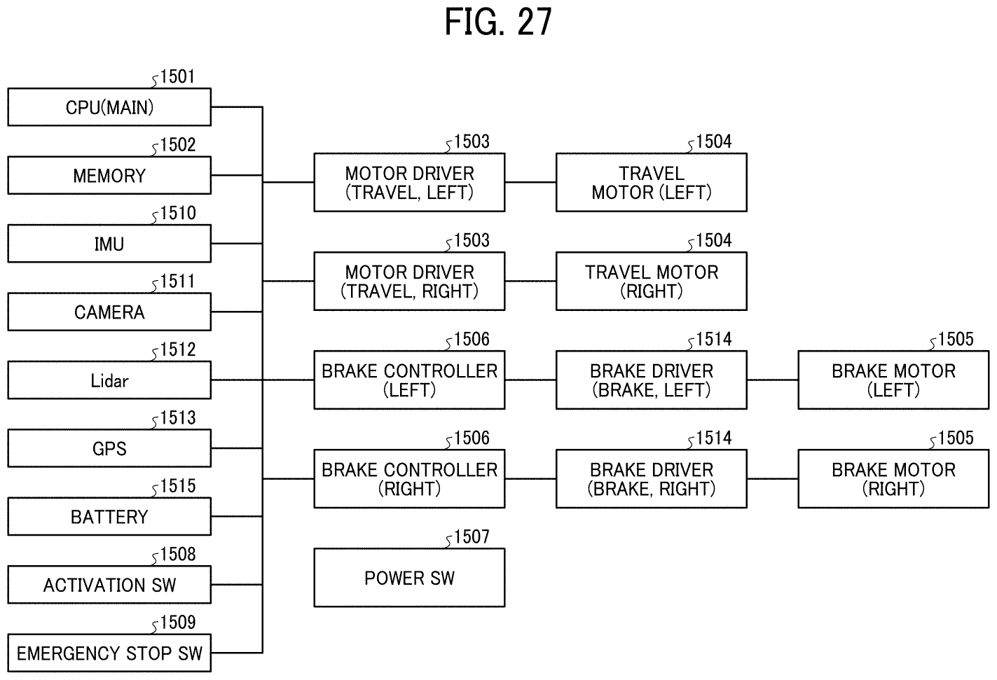

Further, when there is a possibility that the worm gear alone cannot prevent the problem from occurring in relation to safety of the disc brake 51, the disc 511 may be configured to have holes at equal intervals, which may be locked by a solenoid to prevent from rotating, thus, controlling the crawler traveling body 10. In such case, a rod of the solenoid is retracted to unlock when the traveling device 1 is energized (during traveling), and the rod of the solenoid is projected to lock when the traveling device 1 is not energized (during parking). In the present embodiment, the motor 516 is electrically connected to a later-described CPU 1701 (see FIG. 27) which is an example of a motor controller.

In this embodiment, the driving force is transmitted from the motor 516 to the brake caliper 513 by the control line 517 to control driving of the crawler traveling body 10, but the present invention is not limited thereto. For example, the driving force from the motor 516 may be transmitted to the brake caliper 513 by a hydraulic system. In a case where the control line 517 is used as means for transmitting the driving force from the motor 516 to the brake caliper 513, the physical distance between the brake caliper 513 and the motor 516 is to be kept constant, such that the motor 516 is attached to the brake holder 514. In a case where the driving force from the motor 516 is transmitted to the brake caliper 513 by a hydraulic system, there is no such limitation. Specifically, the motor 516 may be attached to the side plate 20a (an example of the main body) of the crawler traveling body 10.

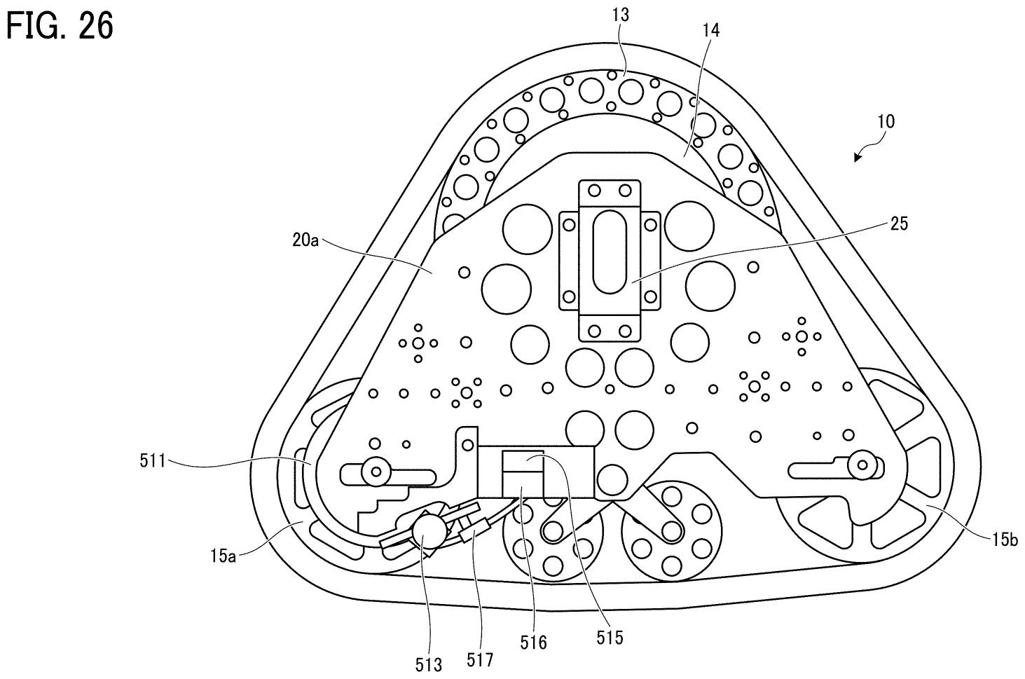

Referring next to FIG. 26, another example method of mounting the disc brake 51 of the traveling device 1 is described according to the embodiment. FIG. 26 is a view illustrating another example method of mounting the disc brake of the traveling device according to the embodiment.

In FIGS. 24 and 25, the brake holder 514 is attached to the motor shaft 141, which is an axis of the driving wheel 13 that is provided, in a manner swingable, on the side plates 20a and 20b of the crawler traveling body 10. In another example, as illustrated in FIG. 26, in a case where the disc brake 51 is attached to wheels (rolling wheels 15a and 15b) that do not swing, the brake holder 514 may be attached to the side plate 20a.

In this case, the disc 511 is connected (coupled) to the rolling wheel 15a (an example of a wheel) by the disc connector 512. That is, the disc connector 512 is an example of a disc connector that connects the rolling wheel 15a and the disc 511 and rotates the rolling wheel 15a and the disc 511 together. In the present embodiment, the disc connector 512 is attached the rolling wheel 15a and the disc 511 at a fixed position.

The brake caliper 513, the gear box 515, and the motor 516 are attached to the side plate 20a via the brake holder 514.

Referring next to FIG. 27, an example hardware configuration of the traveling device 1 is described according to the embodiment. FIG. 27 is a block diagram illustrating an example hardware configuration of the traveling device 1 according to the embodiment.

As illustrated in FIG. 27, the traveling device 1 according to the embodiment includes a central processing unit (CPU) 1501, a memory 1502, a motor driver 1503, a travel motor 1504, brake motors 1505, brake controllers 1506, a power supply switch (SW) 1507, an activation SW 1508, an emergency stop SW 1509, an inertial measurement unit (IMU) 1510, a camera 1511, a light detection and ranging (LIDAR) 1512, a global positioning system (GPS) 1513, brake drivers 1514, and a battery 1515.

The CPU 1501 controls the entire traveling device 1. The memory 1502 is a temporary storage area for the CPU 1501 to execute such as a program for controlling travel. The motor driver 1503 is a driver for the travel motor 1504. The brake driver 1514 is a driver for the brake motor 1505. The travel motor 1504 is a motor that drives the crawler traveling body 10 such as the in-wheel motor 14. The brake motor 1505 is a motor, such as the motor 516, for opening and closing the brake pads 513a and 513b.

The brake controller 1506 receives a command from the CPU 1501 and controls the disc brake 51. Specifically, the brake controller 1506 receives a command from the CPU 1501, and controls the degree of opening and closing of the brake pads 513a and 513b by controlling the motor 516 in accordance with the command. As described above, the crawler traveling body 10 is provided with a brake function, while keeping its characteristics as the small-sized crawler traveling body. Further, it is easy to mount the brake function on the crawler traveling body 10, such that it becomes easy to post-install the brake function.

The power supply SW 1507 is a switch that turns on or off the power source of the traveling device 1. The activation SW 1508 is a switch for starting driving of the crawler traveling body 10. The emergency stop SW 1509 is a switch for stopping the crawler traveling body 10 in case of emergency.

The IMU 1510 determines posture of the traveling device 1 based on sense data obtained from a three-axis accelerometer or a rotational angular velocity sensor. Examples of the camera 1511 include a spherical camera, a stereo camera, an infrared camera, etc. The Lidar 1512 irradiates the object with laser light, measures a time required for the laser light to reach the object to be reflected, and calculates a distance to the object and a direction in which the object exists based on the measured time. The GPS 1513 receives radio waves from the satellite, and measures the position of the traveling device 1 on the earth based on the received result.

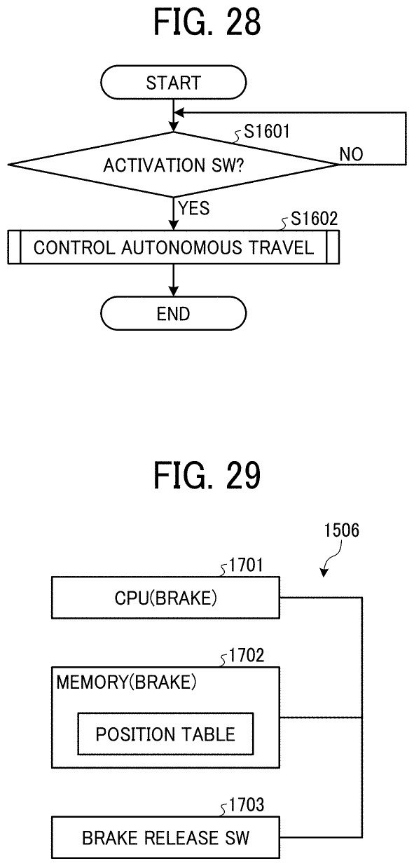

Referring next to FIG. 28, example processing of controlling autonomous traveling of the traveling device 1 is described according to the embodiment. FIG. 28 is a flowchart illustrating an example processing of controlling autonomous traveling of the traveling device according to the embodiment.

The processing starts as the traveling device 1 is powered on. The CPU 1501 polls a signal from the activation SW 1508 and determines whether the activation SW 1508 has been pressed (S1601). When the activation SW 1508 is pressed (S1601: Yes), the CPU 1501 executes processing of controlling autonomous traveling of the traveling device 1 (S1602). When the activation SW 1508 is not pressed (S1601: NO), the operation ends.

Next, referring to FIG. 29, an example hardware configuration of the brake controller 1506 included in the traveling device 1 is described according to the embodiment. FIG. 29 is a diagram illustrating an example hardware configuration of the brake controller 1506 included in the traveling device 1 according to the embodiment.

In the present embodiment, as illustrated in FIG. 29, the brake controller 1506 includes a CPU 1701, a memory 1702, and a brake release SW 1703. The CPU 1701 controls the disc brake 51. Specifically, the CPU 1701 functions as an example of a motor controller that receives a command from an external device such as the CPU 1501, and controls the degree of opening and closing of the brake pads 513a and 513b by controlling the motor 516 according to the command. The memory 1702 is a temporary storage area for the CPU 1701 to execute a control program related to controlling operation of the disc brake 51. The memory 1702 further stores various kinds of information such as a position table to be described later.

The brake release SW 1703 is an example of a release switch that instructs release of the disc brake 51. When the release of the brake pads 513a and 513b is instructed from the brake release SW 1703, the CPU 170 releases the brake pads 513a and 513b. When a trouble occurs in the crawler traveling body 10 at a job site or the like, it is necessary to move the traveling device 1 to an appropriate place in order to perform maintenance work of the crawler traveling body 10 while the power source of the traveling device 1 is turned off. At this time, when the disc brake 51 is engaged, it may be difficult to move the traveling device 1.

Therefore, in this embodiment, by providing means (a mechanical brake mechanism or an electric brake mechanism) for operating the brake release SW 1703 to release the disc brake 51, the crawler traveling body 10 can be manually moved in a state where the disc brake 51 is released. In addition, when the brake release SW 1703 is operated, the brake mechanism is configured to only release the disc brake 51. Thus, it is possible to reduce an operation error of the user, thus ensuring security of the traveling device 1.

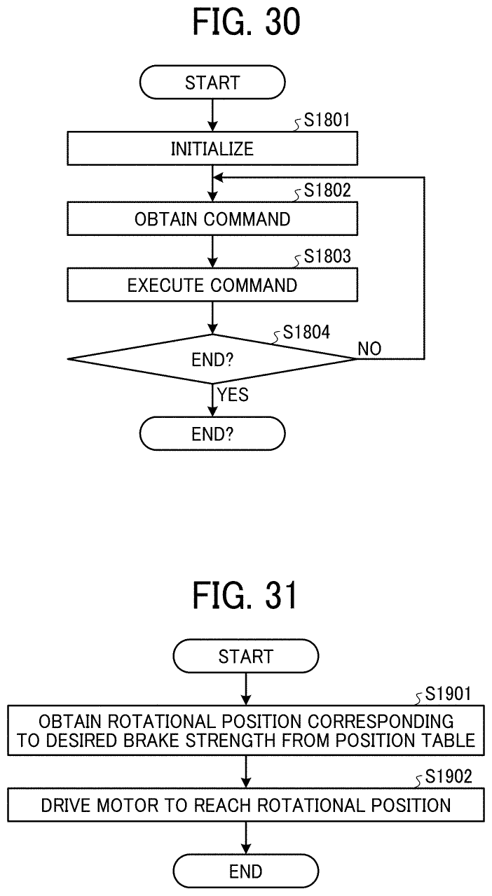

FIG. 30 is a flowchart illustrating example processing executed by the brake controller included in the traveling device according to the embodiment. Referring next to FIG. 30, example processing executed by the brake controller 1506 of the traveling device 1 is described according to the embodiment.

When the activation SW 1508 of the traveling device 1 is pressed, the CPU 1701 executes initialization processing of the brake controller 1506 (S1801). The CPU 1701 then obtains the command from the CPU 1501 (S1802). Next, in accordance with the acquired command, the CPU 1701 controls the motor 516 to execute control processing of the degree of opening and closing of the brake pads 513a and 513b (S1803). Thereafter, the CPU 1701 determines whether or not the command has been executed (S1804). When the command has not been executed (S1804: No), the CPU 1701 returns the operation to S1802 and acquires the command from the CPU 1501. On the other hand, when the command has been executed (S1804: Yes), the CPU 1701 ends the control processing.

FIG. 31 is a flowchart illustrating example processing of controlling a motor, performed by the brake controller of the traveling device, according to the present embodiment. Referring next to FIG. 31, example processing of controlling the motor 516, executed by the brake controller 1506 of the traveling device 1, is described according to the embodiment.

First, the CPU 1701 acquires, from the position table, a rotational position of the motor 516, which corresponds to the strength of the disc brake 51, indicated by the command received from the CPU 1501 (S1901).

In this example, as illustrated in Table 1 below, the position table is a table that associates the strength of the brake of the disc brake 51 (or the degree of opening or closing of the brake pads 513a and 513b) with the rotational position of the motor 516. In the present embodiment, the memory 1702 stores the position table. For example, when the strength of the disc brake 51 indicated by the command acquired from the CPU 1501 is “moderate”, the CPU 1701 acquires the rotational position “950” of the motor 516 associated with the strength “moderate” of the disc brake 51 from the position table.

TABLE 1

| Brake strength | Rotational position of motor |
|---|---|
| Open | 0 |
| Weak | 700 |
| Moderate | 950 |
| Strong | 1000 |
| Maximum | 1100 |

Next, the CPU 1701 controls the degree of opening and closing of the brake pads 513a and 513b by rotating the motor 516 in accordance with the acquired rotational position of the motor 516 (S1902).

When the disc brake 51 is attached to the crawler traveling body 10, or the control line 517 is reattached, the relationship between the strength of the disc brake 51 and the rotational position of the motor 516 in the position table may change. Further, the relationship between the strength of the disc brake 51 and the rotational position of the motor 516 in the position table also changes due to wear, elongation, and the like of the control line 517.

Therefore, in the present embodiment, the CPU 1701 updates the position table, which associates the strength of the disc brake 51 with the rotational position of the motor 516. The rotational position of the motor 516 is equivalent to the rotational position of the pulley 516c pulling the control line 517. Therefore, the rotational position of the motor 516 can be converted into the pulled length of the control line 517.

Therefore, with the rotational position of the motor 516 corresponding to a predetermined strength of the disc brake 51 as the origin, the CPU 1701 obtains in advance, as a difference in the rotational position of the motor 516, how much the tension of the control line 517 should be relaxed to change the strength of the disc brake 51 to “moderate”, “weak”, or “open”. In this example, the predetermined strength is a strength set in advance and is a strength in a state where the control line 517 is pulled with a predetermined torque. In the present embodiment, in order to improve the reliability of the disc brake 51, “strong”, which is the strength of the disc brake 51 for pulling the control line 517 with a torque larger than a normal torque, is set as the predetermined strength.

The CPU 1701 uses a position conversion table illustrated in Table 2 below to update the position table in which the respective strengths of the disc brake 51 and the rotational positions of the motor 516 are associated with each other, with the rotational position of the motor 516 for “strong”, which is an example of the predetermined strength, being a reference. As illustrated in Table 2, the position conversion table is a table in which the strength of the disc brake 51 and the difference in the rotational position of the motor 516 for each strength are associated with each other.

TABLE 2

| Brake strength | Positional difference from “Strong” |
|---|---|
| Open | −1000 |
| Weak | −300 |
| Moderate | −150 |
| Strong | 0 |
| Maximum | 100 |

That is, it is desirable to adjust the effectiveness of the disc brake 51, for example, depending on extension of the control line 517 or wearing of the brake pads 513a and 513b at the time of attaching the disc brake 51 to the crawler traveling body 10 and thereafter, which takes time and effort. Therefore, in the present embodiment, the CPU 701 is configured to update the position table that associates the strength of the disc brake 51 (the degree of opening and closing of the brake pads 513a and 513b) and the rotational position of the motor 516. The calibration of the position table can be performed automatically and easily at any desired time, so that the effectiveness of the disc brake 51 can always be maintained in a desirable state.

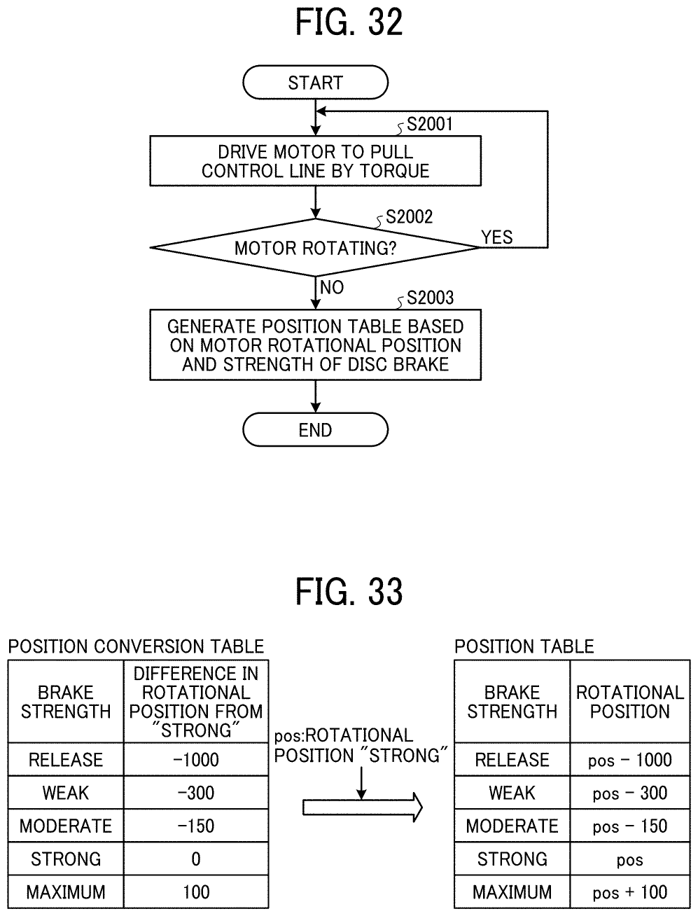

Referring next to FIGS. 32 and 33, example processing of updating the position table, performed by the traveling device 1, is described according to the embodiment. FIG. 32 is a flowchart illustrating example processing of updating the position table by the traveling device according to the embodiment. FIG. 33 is a diagram illustrating example processing of updating the position table by the traveling device according to the embodiment.

First, the CPU 1701 drives the motor 516 to pull the control line 517 with a predetermined torque in a direction so that the brake pads 513a and 513b are closed (S2001). Next, the CPU 1701 determines whether or not the motor 516 is rotating (S2002).

When the motor 516 is rotating (S2002: Yes), the CPU 1701 returns processing to S2001 and continues to drive the motor 516. In this example, “the motor 516 is rotating” means that the strength of the disc brake 51 is increasing. On the other hand, when the motor 516 is stopped (S2002: No), the CPU 1701 obtains the rotational position of the motor 516 for each strength of the disc brake 51, with reference to the rotational position of the motor 516 associated with the strength of the motor 516 at that time, by referring to the position conversion table as illustrated in FIG. 33. In this example, the state in which the motor 516 is stopped is a state in which the strength of the disc brake 51 reaches “strong” and is maintained. That is, when the motor 516 is stopped, the strength of the disc brake 51 reaches “strong” and the control line 517 is not pulled any more in the direction so that the brake pads 513a and 513b are closed.

Then, as illustrated in FIG. 33, the CPU 1701 creates a position table that associates the strength of the disc brake 51 with the rotational position of the motor 516 for each strength (S2003). Thus, the disc brake 51 can be attached to the crawler traveling body 10, without taking into account the tension of the control line 517 at the time when the disc brake 51 is attached to the crawler traveling body 10. Further, the tension of the control line 517 can be easily adjusted during the operation of the traveling device 1.

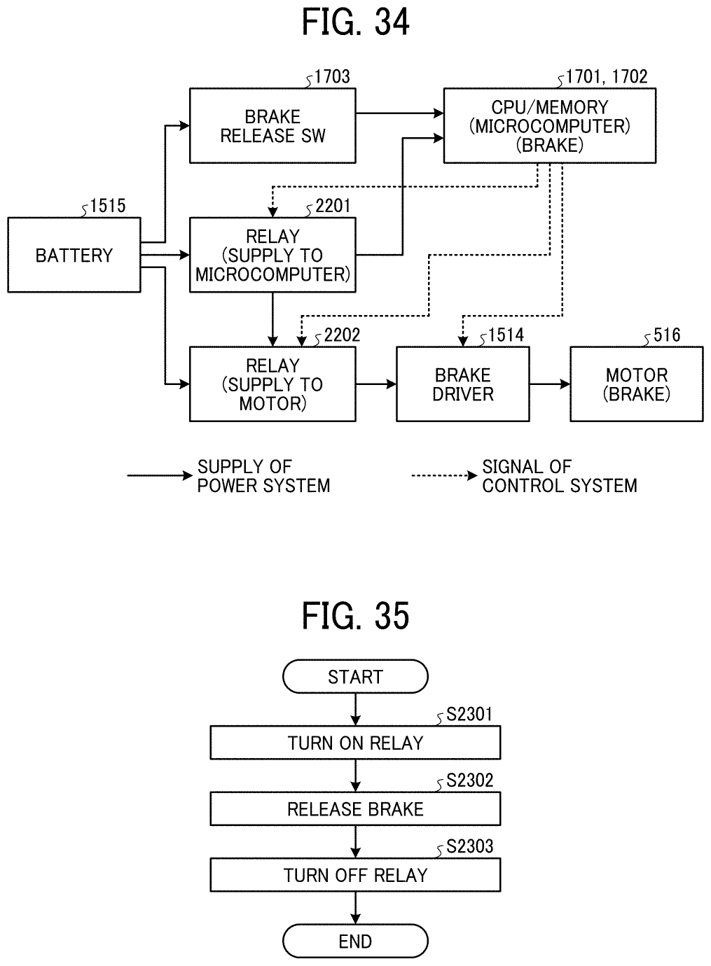

Referring now to FIGS. 34 and 35, example processing of releasing the brake pads 513a and 513b in response to pressing of the brake release SW 1703 of the traveling device 1 is described according to the embodiment. FIG. 34 is a diagram schematically illustrating a mechanism to release (open) the brake pads in response to pressing of the brake release SW at the traveling device, according to the embodiment. FIG. 35 is a flowchart illustrating example processing of releasing the brake pads in response to pressing of the brake release SW at the traveling device 1 according to the embodiment.

In this embodiment, when the brake release SW 1703 is pressed, the CPU 1701 turns on the relay 2201 that controls power supply to the brake controller 1506 (for example, microcomputer), and the relay 2202 that controls power supply to the motor 516 (S2301). This maintains power supply from the battery 1515 to the brake controller 1506 and the motor driver 1503. Thereafter, the CPU 1701 controls the motor 516 via the brake driver 1514 to release the disc brake 51 (S2302).

When the disc brake 51 is released, the CPU 1701 turns off the relay 2201 and the relay 2202 (S2303). In this embodiment, the disc brake 51 is released by an electric brake release mechanism, however, the disc brake 51 can alternatively be released by a mechanical brake release mechanism. For example, it is also possible to release the disc brake 51 by means of a mechanism which releases the connection (fixing) of the control line 517 to the brake caliper 513, or a mechanism which releases the connection (fixing) of the disc 511 to the driving wheel 13.

As described above, according to the traveling device 1 of the present embodiment, the crawler traveling body 10 is provided with a brake function, while keeping its characteristics as the small-sized crawler traveling body. Further, the brake function can be easily mounted on the crawler traveling body 10.

In one exemplary aspect, in a first example, a crawler traveling body is provided, which includes: a wheel around which a crawler belt is wound; a disc; a disc connector configured to connect the wheel and the disc, and rotate the wheel and the disc together; a brake caliper configured to sandwich the disc with a brake pad; and a motor configured to open or close the brake pad. A motor controller (motor control circuitry) controls the motor to control a degree of opening or closing of the brake pad.

In one exemplary aspect, in a second example, the crawler traveling body of the first example further includes a brake holder configured to hold the brake caliper. The wheel is provided so as to be swingable with respect to a main body of the traveling device, and the brake holder is attached to an axle of the wheel.

In one exemplary aspect, in a third example, the crawler traveling body of either the first example or the second example further includes a worm gear configured to transmit power from the motor to the brake pad to control the degree of opening or closing of the brake pad.

In one exemplary aspect, in a fourth example, the crawler traveling body of any one of the first to third example further causes the motor controller to store in a memory a position table associating a strength of the brake by the brake caliper and a rotational position of the motor, and update the position table.

In one exemplary aspect, in a fifth example, for the crawler traveling body of any one of the first to fourth example, a release switch that instructs release (opening) of the brake pad is provided. The motor controller releases the brake pad in response to reception of an instruction to release the brake pad from the release switch.

According to at least one embodiment, a brake function can be easily mounted on the crawler traveling body without increasing the size of the crawler traveling body.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above. The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A crawler traveling body comprising:
a wheel around which a crawler belt is wound;
a disc;
a disc connector configured to connect the wheel and the disc, and rotate the wheel and the disc together;
a brake caliper configured to sandwich the disc with a brake pad; and
a motor configured to open or close the brake pad according to a control signal for controlling a degree of opening or closing of the brake pad.

2. The crawler traveling body of claim 1, further comprising:
a brake holder configured to hold the brake caliper, wherein
the wheel is provided so as to be swingable, and
the brake holder is attached to an axle of the wheel.

3. The crawler traveling body of claim 1, further comprising:
a worm gear configured to transmit power from the motor to the brake pad to control the degree of opening or closing of the brake pad.

4. A traveling device comprising:
at least one crawler traveling body of claim 1; and
motor control circuitry configured to output the control signal to drive the motor to control the degree of opening or closing of the brake pad.

5. The traveling device of claim 4, wherein
the motor control circuitry stores in a memory a position table associating a brake strength by the brake caliper and a rotational position of the motor, and updates the position table.

6. The traveling device of claim 4, further comprising:
a release switch configured to instruct to release the brake pad, wherein
the motor control circuitry releases the brake pad in response to reception of an instruction to release the brake pad from the release switch.
